(19) United States
(12) Patent Application Publication
(10) Pub. No.: US 2007/0192229 A1
(43) Pub. Date: Aug. 16, 2007

(54) Transaction management system and method

(75) Inventor: Nicholas David Wingham Rowan, London (GB)

Correspondence Address: BROOKS KUSHMAN P.C., 1000 TOWN CENTER, TWENTY-SECOND FLOOR, SOUTHFIELD, MI, 48075, US

(73) Assignee: GUARANTEED MARKETS LTD, London (GB)

(21) Appl. No.: 10/599,030

(22) PCT Filed: Mar. 17, 2005
(86) PCT No.: PCT/GB05/01148

§ 371 Date: Sep. 18, 2006

(30) Foreign Application Priority Data
Mar. 17, 2004 (GB) 0406076.0

(51) Int. Cl. G06Q 40/00

(52) U.S. Cl. 705/37

(57) ABSTRACT

The present invention relates to the field of online commerce. In particular it relates to the operation of electronic markets in which there are plurality of sellers.

### FIELD OF THE INVENTION

The present invention relates to the field of online commerce. In particular it relates to the operation of electronic markets in which there are a plurality of sellers.

### BACKGROUND OF THE INVENTION

Buying and selling online is conducted through a variety of mechanisms for matching the buyer and seller. These mechanisms include online catalogues, auctions, bid/ask systems, aggregating of buyers, request-for-quote services and bulletin board listings. Each mechanism is strong for certain types of transaction and weak for others.

The mechanisms above can be divided between those that allow immediate purchasing of pre-determined goods or services and those that accommodate irregular purchase requests but require more time for a purchase to complete.

An online catalogue of the type accessed at Amazon.com for example allows goods that have been described by the seller to be displayed to buyers at a price set by the seller. Similarly items auctioned on sites such as ebay.com are described by the seller but he then waits to see what price the market will pay for his offering. Bid/ask services such as that operated by Priceline.com and described in U.S. Pat. No. 5,794,207 require buyers to define a specific item or range of items to be purchased, typically an airline ticket between two points in a given date range, then wait to see if that need will be matched from a seller's database of pre-described offerings.

By contrast a buyer accessing a request-for-quote service such as that operated by guru.com is able to define his particular needs of the moment, a day of web design work at a specified location for instance, and then receive quotes from sellers who, having digested his requirements, quote a price at which they are willing to fulfil his need. This is time consuming for all concerned. Buyers must wait for a range of sellers to reply to their request to be sure of a fair price. Sellers must take the time to understand buyers' requirements and bid, knowing they may not be successful in getting the business.

The time consuming nature of online transactions in which the buyer is able to define his exact needs rather than shopping between various options pre-defined by sellers makes existing mechanisms impracticable for many transactions. They include short notice purchases or small purchases where the sum involved does not merit the attention of sellers or the waiting of buyers.

Ideally, in many markets, a buyer would wish to define his exact requirements of the moment and immediately be given a list of sellers specifically available and ready to meet that need. For instance his need might be “I want a temporary secretary to work from 2.00 to 6.00 this afternoon at my office”. He would then wish to see an immediate list of sellers who were (a) qualified to work as secretaries (b) in the vicinity of his office (c) willing to work this afternoon (d) currently willing to accept assignments at short notice (e) currently willing to accept assignments of only a few hours duration (f) could be contacted in time to receive details of this period of work.

Existing mechanisms are of little use to such a buyer. A bulletin board for instance will reveal a list of possible secretaries who can be emailed to see if they meet the characteristics above. An auction would be too time consuming for the buyer who could more easily phone a temporary worker supply agency. An online catalogue that simply allows the buyer to browse a list of offerings is again too time consuming for this buyer. Bid/ask type services require the buyer to input the price he will pay rather than allowing a market rate to be established.

To overcome this gap in the art the present inventor has previously disclosed elements of an online buyer/seller matching system called “GEMs”. Such a system is defined by an ability to take in a buyer's requirements and immediately construct options specific to his needs based on broader inputs from any number of sellers. Any of these options can then be purchased immediately. Such a system could run a plurality of markets in different sectors, for example such markets might include: bicycle hire, hire of a driving instructor or short notice office cleaning services.

FIG. 1 shows the buyer input screen for such a system as completed by a buyer who is seeking to book a temporary secretary. FIG. 2 shows the options returned immediately by such a system. These are not bulletin board style listings showing potential sellers who may possibly be available and possibly be interested in this transaction. They are specific options built around the buyer's inputs priced and ready for purchase.

Such a system holds considerable information about each seller which can be searched in the light of a specific buyer's enquiry. Each seller displayed on the screen represented at FIG. 2 has previously specified parameters within which they are willing to sell. These may include geographical area, period-of-notice for an assignment and length of assignment. This information is stored. All of those parameters are met by this requirement for each seller on the screen. The system has also checked that the seller is showing availability in an online availability diary this afternoon and that their diary of times when they undertake to be reached, for instance by mobile phone text message or email, would allow them to be notified of this transaction in time. The buyer can choose any one of these sellers and the system will inform the individual of the assignment regarding them as sold and making the required amendments to their availability diary.

Aspects of the GEMs system have been disclosed in publications by the present inventor. An overview of one embodiment of such a system will now be provided to illustrate one form of underlying architecture for the present invention. Referring first to FIG. 3, this shows a generalised embodiment 300 of a system that might underlie the present invention. Such a system would run a number of markets in different sectors, examples of sectors include: secretarial services, office rental and vehicle hire.

A Communications Network 303 is connected to Seller Terminals 301a and b and Buyer Terminals 302a and b and to a System Communications Interface 304. The communications network may comprise any conventional communications network such as a telephone network or the Internet. The communications network couples the buyer and seller terminals to the System Communications Interface 304 to provide user interfaces to the system to allow buyers and sellers to request and execute transactions using the system.

The Communications Interface 304 is coupled to a Communications Processor 305 which creates screens and messages for communicating with buyer and seller terminals 302 and 301. The communications processor is connected to an Application Processor 306 for providing transaction management applications. Application Processor 306 is also coupled to a system service provider terminal 308 to allow a system service provider/operator direct access to aspects of the system to which access via Communications Network 303 is restricted for security reasons. Thus Service Provider Terminal 308 may be used for system management, account management, program code updating, setting a mark-up on each transaction within the system for operator revenue purposes and similar functions. In an alternative embodiment Service Provider Terminal 308 may be connected through a wider communications medium such as the Internet.

Application Processor 306 is coupled to Data Store 307 storing system-related data. It is also able to communicate with external servers that perform specific additional tasks for the benefit of system users. Thus Application Processor 306 can process data for output to buyer and seller terminals 302 and 301 and Communications Processor 307 can access the data to send and receive messages to and from terminals 302 and 301. Thus data in Data Store 307 is indirectly accessible via buyer and seller terminals 302 and 301.

The Communications Interface 304, Communications Processor 305, the Application Processor 306 and the Data Store 307 may all be provided within a single general purpose computer or these functions may be distributed over a plurality of machines in a manner well known to those skilled in the art.

The Communications Network 303 in this embodiment is the Internet to which are coupled Buyer Terminals 302a and b and Seller Terminals 301a and b. Also coupled to Internet 303 is a gateway (not shown) to a mobile phone network 309 (or, more generally, any mobile communications network) which communicates with a Mobile Station 311, such as a phone handset, using base transceiver station 310.

FIG. 4 illustrates a preferred embodiment for the system's architecture within a central server. Communications Processor 305 interacts with Communications Interface 304 to receive inputs and forward output communications to buyers and sellers. Application Server 306 contains software modules allowing new users accessing the system through the communications network to register as sellers 421 or buyers 422, or both. Transaction Management Module 423 extracts market rules information from the data store to govern information displayed to users in a particular market and the prioritization of searches. Assembly of Options Module 424 receives lists of relevant sellers after a search and applies rules on their filtering and display. In its simplest embodiment this module sends all sellers returned by the search to the Communications Processor 305. Price Construction Module 425 takes the list of sellers produced by

Assembly of Options Module 424 and constructs the unit price at which each seller will fulfill this buyer's specified needs.

Once a buyer has selected a seller he wishes to purchase, Post Sale Management Module 426 compiles the information about the buyer and transaction that is required to inform the seller of all required details of the sale. Payment transfer module 427 ensures value is transferred from buyer to seller according to instructions in the market rules data store. This might involve credit card processing, transfer of digital value, holding sums in escrow or raising of an online invoice. It may entail breaking the transaction down into parts, the completion of each triggering part payment. Typically this could be achieved by means of a timesheet signed by buyer and seller using their system passwords at the end of each week of a booking. All these processes will be familiar to one skilled in the art and can be performed by widely available software.

User Maintenance Module 428 applies rules to the seller and buyer data store as instructed through the Service Provider Terminal 308. These might include for instance generating email to any user who has not been active in the last 6 months asking that they confirm the email address, and therefore their identity, is still valid.

The Data Store 307 comprises firstly a Database Of Sellers 431. For each seller this includes unique identifying code, name, password, date of birth, contact details, time and date of registration, unit price to be charged to buyers, history of transactions performed plus earnings and details of how payments are to be transferred. For each seller there is additional data stored which can be changed at any time by the seller to which it pertains. Selling Parameters Record 431a stores that seller's preferences for sales, for instance how far from their base travel code they are willing to travel. Seller Availability Record 431b stores data input by the seller about the times when they are available to be sold by the system. Seller Contactability Record 431c stores data of the times the seller undertakes to be available for contact by the system and the means by which messages should be sent.

Buyer Database 432 includes information about each buyer on the system. This includes unique identifying code, name, administrator password, headquarters address, time and date of registration, details of other users within the buyer's account allowed to buy on its behalf (named members of staff for example), how payments are to be collected, history of transactions and payments made and the information to be displayed to sellers, for instance showing locations of the buyer's buildings at which they may be required to work.

Transaction Database 433 records details of all transactions on the system. A preferred embodiment of this database includes the following record of any purchase or partly completed purchase: unique identifying code, market in which purchase was made, identity of buyer, identity of seller, time purchase initiated, number of units bought (hours of work for instance), dates units were to be supplied, times of day units were to be supplied, price paid per unit, selling parameters pertaining to this transaction and current status of the transaction which can be only one of the following exemplary list: waiting for seller confirmation/not confirmed/confirmed/in progress/cancelled/completed.

Market Rules Database 434 stores information pertaining to each market sector. Wording and options required to make up screens or messages for the user are extracted by Communications Processor 304. Market Rules Database 434 also stores rules on admission to a market, for instance “only sellers over 18 permitted” or “no more than 50 hours to be sold by any individual seller in one 7 day period”.

In the above-described aspects of the system communication between the system operator or intermediary and/or buyer and/or seller may be by any convenient communication means, but the system is particularly suited to implementation using an electronic communications network such as the Internet, and Intranet, or an Extranet, or wireless mobile communications.

In preferred embodiments the system is implemented on general purpose computer systems using appropriate software. The software may comprise instructions in one or more of HTML, XML, Java, Perl or other programming languages. Thus aspects of the system may be embodied in computer program code, either as separate applications or parts of a single program. As the skilled person will appreciate, such program may comprise source, object or executable code and code may be implemented on a single machine or shared between different hardware platforms. Such program code may be provided on any conventional carrier medium such as tape, disk, CD-ROM, programmed memory or on an electrical or optical signal carrier. The processor implementable instructions of the buyer and seller terminals may be stored on a network server and provided to the terminal as needed, for example as an Internet data page or web page.

Processes used in such a system will now be described. For ease of understanding the operation of the system will be described with reference to a specific example of the system's use, that of providing temporary secretaries to employers. However use of the system is not restricted to this application.

Listing Goods or Services to be Sold

A new seller will typically enter the system through a portal accessed via the Communications Network 303 and constructed by the Communications Interface 304. This page is able to activate the Seller Registration Module 421. Having taken details of the individual or company, this module then offers a selection of markets in which anyone might register to sell. Thus a new seller might be asked “what do you wish to sell” and then offered a first selection list which includes “my time”. This response prompts a second list from which she chooses “formal temporary work” and then “secretarial work”. A seller can choose to sell in multiple market sectors. A seller may not be named as an individual but simply as “secretary from XYZ Agency”. They are then invited to input the pricing data that allows their price for a transaction for which they are applicable to be constructed. In its simplest embodiment this requires only that they specify a flat-rate price for each unit of sale or part thereof. In the temporary work market the unit of sale is hours.

Thus the system knows the individual's name, contact details, including email address and optional mobile phone number, and that she wishes to sell her time as a temporary secretary at, for example, $8.35 an hour. These details are recorded in seller database 431.

At this point the Seller Registration Module 421 asks the questions that allow this user's parameters for any potential sale to be stored in the Seller Parameter Record 431a. A list of parameters relevant to sales in the secretarial market are accessed from the market rules database 434. They may include:
Geography (for example: “My home postal code is X and I will not work more than Y miles from that point”)
Size of purchase (for example: “I will not accept bookings of less than 4 hours” or “I will not accept bookings lasting more than 10 working days”)
Period of notice for purchase (for example: “I only accept bookings where I have at least 24 hours notice of the job”)

Additionally the seller may be able to define specific buyers registered on the Buyer Database 432 with whom they are unwilling to trade. This is recorded on the Seller Parameter Record 431a.

The new seller is then offered a blank diary of time blocks, possibly in half hour increments, covering each day for the remainder of the current week. She can click through to further pages covering following weeks. By selecting certain blocks she is able to select the precise times when she is available to work. This is stored in the Seller Availability Diary 431b. By default this diary remains blank with no availability until the seller has input details of her willingness to work.

In a further embodiment the seller is now presented with a second set of diary pages and asked to input times when she undertakes to be contactable by the system. These are periods when she will be logged on to receive email or will have her mobile phone switched on and about her person to receive text messages. This data is stored in the Seller Contactability Record 431c.

Thus it will be clear that the Seller Database 431 now holds details of the individual's identity (including password), market or markets in which they wish to sell, their unit price, the constraints on any sale they will accept, the times they are available to sell their chosen goods or services sold by the system and the times at which they can be contacted by the system. Any part of this information can be changed at any time by the seller logging on and triggering the User Maintenance Module 427. This will display current choices stored in the Seller's Parameter Record 431a, Availability Diary 431b and Contactability Record 431c. The seller can then choose to overwrite her current preferences.

The above example pertains to a potential seller wishing to sell their time. It will be clear the architecture described could equally accept listings for other services. For example: load space on trucks, domestic storage capacity, sales of organic produce or childcare. In each case the Market Rules Database 434 would provide a list of relevant parameters to be completed by the seller. An example of the selling parameters by which sellers can define their willingness to sell based on a buyer's specific needs for some further markets will now be given.

| MARKET | UNIT OF SALE | SELLING PARAMETERS |
|---|---|---|
| Overnight accommodation | Night | Length of stay/time of arrival/time of departure/ |
| | | number of people in room/smoker or non-smoker/ |
| | | period of notice to hire |
| Hire of agricultural tractors | Hour | Distance to buyer/anticipated hours of work within |
| | | the hire/length of hire/period of notice to hire |
| Local deliveries | Mile | Period of notice to pick up/distance from seller |
| | | postalcode to pick up point/length of journey/ |
| | | distance from seller postalcode to drop-off point/ |
| | | weight of object to be delivered/size of object to be |
| | | delivered |
| Specially commissioned | Kilogram | Smallness of cake/largeness of cake/style of cake |
| home cake baking | | (selected from drop down boxes)/period of notice |
| | | before delivery/delivery method/additional |
| | | trimmings (selected from drop down boxes) |

The Purchase Process

A new buyer accesses the system through Communications Interface 304 and is shown a generic welcome page generated by Communications Processor 305. From this the new buyer is able to trigger Buyer Registration Module 422. This sends pages requesting information, validates that information and uses it to populate a record in Buyer Database 432. Confirmation of the buyer's means to pay may be obtained through a link to an external agency such as a credit card supplier using Communications Network 303 before purchasing is allowed. This process is well known to those in the art.

A buyer wishing, and permitted, to make a purchase can trigger the Transaction Management Module 423. This will offer a page such as that shown in FIG. 1 that establishes the following. (a) What he wishes to purchase (for example: the time of a temporary secretary) This information is sent to the Market Rules Database 434 which provides the parameters which must be defined to enable a search of the Seller Database 431. (b) The quantity he wishes to purchase (for example by defining a period of daily hours which the system can multiply by the number of days input at the next step). (c) The times he wishes to purchase (for example: by defining a start and end date for a booking). (d) The geography in which he wishes the purchase to be realized (for example: place of work is postal code Y).

Transaction Management Module 423 will ensure all required information is in place before beginning a search. Once the required inputs have been completed the Transaction Management Module creates a record on the Transaction Database 433. A unique identifier code for this transaction is established at the time of storage. The Transaction Management Module 423 then initiates a search of the Seller Database 431 based on the buyer inputs. The search is performed by Assembly of Options Module 424. It excludes those sellers who are among any of the following. (a) Not selling the services/goods the buyer wishes to purchase. (b) Not willing to sell in the area defined by the buyer. (c) Not willing to sell the number of units (for example hours) demanded by the buyer. (d) Not willing to sell with the period of notice for this transaction. (e) Not available at the dates and times the buyer requires. (f) Not contactable in the time required before the purchase.

Thus the Assembly of Options Module 424 is able to return a list of any sellers on the database who meet the following conditions. (a) Selling the services or goods required by the buyer. (b) Willing to sell in the geography required. (c) Willing to sell with the period of notice specific to this job. (d) Available for the times and dates required. (e) Contactable in time for this booking.

This list is sent to Price Construction Module 425. In it simplest embodiment, this module looks up the unit price for each seller on the list, such data being held in Seller Database 431 and multiplies it by the number of units for this sale. Alternatively it may use the selling parameters of the present requirement as outlined in the screen shown in FIG. 1, coupled with a list of pricing preferences from each user, to construct a specific price for this one transaction for each seller. It may also add a mark-up input by the system operator through Service Provider Terminal 308. This provides revenue for the market operator and is retained during any subsequent transfer of payment between buyer and seller. Alternatively the market operator might invoice either party for its transaction fee, or subscription fee, at a future date.

This list of options and their prices is stored in the Transaction Database 433 against the unique identifier for this query. If no sellers are returned the Transaction Management Module 423 creates a message for the buyer suggesting a change of requirements.

The list of sellers and prices thus stored are now sent by the Communications Processor 304 and the Communications Interface 304 to the Buyer Terminal 302. Before doing so Assembly of Options Module 424 may apply rules such as “display in price order from left to right putting identically priced sellers in alphabetical order” or “only display a maximum of 20 sellers on one screen”. Such rules would be input from Service Provider Terminal 308.

One embodiment of such a page is represented in FIG. 2. If the buyer selects “purchase” on any option or options presented to him, that information is stored in the Transaction Database 433. A page of information for the seller has to be completed by the buyer and payment is arranged according to instructions in the Market Rules Database 434 by Payment Transfer Module 427. This module will access proprietary software well known to those in the art such as credit card approval, transfer of digital value between users on the system or invoice generation and return a “payment OK” flag to be recorded on Transaction Database 433.

Once payment arrangements have been confirmed the Post Sale Management Module 426 is triggered. This performs the following tasks. (a) Confirms the seller is still available. If they have removed their availability or been bought by another conflicting buyer since the search showed them to be available the buyer is advised with a message. (b) Removes the appropriate availability from the seller's record in Seller Database 431. (c) Creates a message for the chosen seller revealing the buyer's identity stored in Buyer Database 432 and adding details of his purchase from Transaction Database 432. In a temporary work transaction these would include: place of work, hours of work, days to be worked and information input by the buyer to be passed to the seller. (d) Looks up contact details on the Seller Database 431 and directs the message to email or mobile phone for instance via the Communications Processor 304. (e) Monitors that the seller confirms they will undertake the assignment before the start of work time. If they do not a message is generated for the buyer advising that the seller has not confirmed and the buyer may wish to re-book. (f) Triggers release of payment from escrow funds at a specified point based on rules in the Market Rules Database 434 (for example 48 hours after completion of the transaction). In a temporary work market this would be likely to be based on completed timesheets each of which triggers an invoice. Online timesheets may be based on technology such as Web Timesheet from Adeo Software or the Time product from Artologik Software

It will be appreciated that modules listed above could be combined in practice. Their listing is purely illustrative of the functions to be performed and is not intended to define the system's structure.

Benefits of the System

This is a “spot market” online. Existing systems for buyer/seller matching tend not to allow immediate purchasing from an infinite number of sellers who may have entered the market only minutes earlier. Online bulletin boards offer listings of sellers who may be available for a general need. Internet auctions require time consuming bidding. Using bid/ask systems the buyer must define parameters of the potential purchase which has to be matched by a precise offering defined by the seller.

“GEMs” type markets such as that just described provide a list of named sellers any one of whom can be booked immediately for a buyer's specific requirements. Unlike online catalogues these markets are able to construct a specific offering for a buyer's needs based on much more general inputs by a plurality of potential sellers.

There are potential enhancements to a system as described above that are already in the public domain:

Tailored Price Construction Embodiment.

In this embodiment Seller Parameters Record 431a additionally stores pricing data that can be updated by the seller using a screen generated by User Maintenance Module 428. Each seller is able to have information stored that enables their individual price for each assignment for which they are applicable to be constructed by Price Construction Module 425. In this embodiment each seller gives the system a basic rate for each unit of sale that is stored in Seller Database 431 (for example “my price per hour is $10”). They can then dictate that percentage mark ups be added to that sum based on how the buyer's requirements relate to the individual seller's preferences around parameters relating to that market.

To achieve this, the seller is asked questions by Seller Registration Module 221 relating to the market in which they are selling. In a secretarial market these might include:

“What percentage mark up do you want added to your basic price if a job requires the distance you travel from your home postalcode is: (a) More than 1 mile but less than 2 miles? (b) Between 2 miles and 5 miles? (c) Between 5 miles and 10 miles (d) Between 10 miles and 20 miles? (e) Between 20 miles and 40 miles (f) Over 40 miles?”

It will be appreciated by those skilled in the art that geographical calculations such as this can be computed by comparing seller base postalcode and buyer required postalcode in a variety of ways at the time of search. Typically they include route planning software such as IntelliRoute by Rand McNally or ZipInfo from Scribble software. The seller can select an “X” on any option to signify they should be excluded from the search for jobs with that characteristic.

Similar questions are asked of each seller at the time of registration by Seller Registration Module 421 to produce a set of rules specific to each seller which are stored in the Seller Parameter Record 431a. They might cover the following. (a) Geography: (for example: if the job is more than 1 mile from my home postalcode I charge an extra 10%. If a job is more than 5 miles from my home postalcode I charge an extra 20%). (b) Size of purchase: (for example: if the job is less than 2 hours I charge an extra 10%, if the job is less than 4 hours I charge an extra 5%.). (c) Period of notice to purchase: (for example: “if I have less than 24 hours notice of the job starting I will charge an extra 20%, if I have less than 12 hours notice I will charge an additional 40%.).

It will be clear that the system can thus construct a price at which a relevant seller will complete the buyer's specified requirements. For example:

Basic rate is $10 per hour
Job entails traveling 1.5 miles so add 10% of basic rate=$1
Job is 3.5 hours long so add 5% of basic rate=$0.50
Job entails 75 hours notice of start so percentage mark up input=$0.00

Thus the seller's hourly price for this buyer's requirements are $10+$1+$0.50+$0.00=$11.50.

It will be appreciated that this instant pricing of a buyer's requirements allows individual sellers to offer their goods or services knowing that they will be compensated for the specific aspects of any sale with most matter to the individual seller.

Grading of Sellers Embodiment.

In this embodiment User Maintenance Module 428 promotes sellers up a ladder of grades as they complete specified numbers of trades. Buyers can view relevant sellers produced by the search listed by their grades in the market. Grading data is stored on the Seller Database 431. Users may move automatically through grades as the User Maintenance Module 427 periodically sweeps the seller database checking number of units sold in each market.

Market Overview Embodiment.

By sweeping details of transactions held in the Transaction Database 433 including the sale price, times, dates and geographical point required by buyer a market overview module would be able to plot trends in the market for users. Anyone defining a market sector, a geographical area and a time period can then see data which might reflect the following. (a) Number of units sold in that geographical area/timeframe. (b) Average price of units in that geographical area/timeframe. (c) Number of sellers listing their availability in that geographical area/timeframe. (d) Range of periods of notice of purchases in that geographical area/timeframe.

It will be appreciated that this enables potential sellers to make decisions about market entry. Established sellers can identify patterns of demand. Buyers can select the times or geographies when they can purchase more cheaply.

WIPO patent application WO 02/091100 discloses in detail a GEMs system that allows the transactions of high grade sellers to be economically underwritten by the system operator. Underwritten transactions might have a monetary amount attached that specifies the maximum that can be spent on a replacement purchase. This document is incorporated herein by way of reference material.

UK patent application 0326895.0 discloses in detail a means of encouraging agencies and other market middlemen to register sellers in an online marketplace. This document is incorporated herein by way of reference material.

The present inventor has disclosed basic details of “GEMs” markets in two books: “Guaranteed Electronic Markets; backbone of a 21^{st} century economy?” (Pub: Demos, 1997) and “Net Benefit: Guaranteed Electronic Markets the ultimate potential of online trade” (Pub: Macmillan 1999).

Background to the Present Invention

The present invention concerns the offering of availability by sellers in a marketplace. Any market system which is to offer buyers the prospect of an immediate purchase from any number of potential sellers, rather than simply offering a list of possible sellers who require dialogue to establish whether they will sell what is required, must maintain some record of what is available for sale, when it can be sold and at what price. In a single seller environment this is typically achieved through inventory management software, for example within an online bookstore. More recently yield management disciplines applied for example to airline seats has led to “dynamic pricing” where a seat on a flight is priced according to the proximity of departure or the popularity of the flight. Although flexible, the item being sold is uniformly available to the entire market at the same price.

The present invention provides for a sophisticated system that allows an infinite number of sellers to control their individual availability and pricing with extraordinary precision. The technology disclosed can immediately assess whether any one of many thousands of sellers is available for a particular transaction based on: any combination of parameters of that transaction, events in the wider market and their own needs in an market. The market in which they are selling may be of the “GEMs” type outlined above or any other forum in which sellers list their willingness to sell at specified times in advance of those times. Once a seller is deemed to be available for a particular transaction the price at which they personally will fulfil it can also be instantly calculated.

Typically this functionality will be most useful in markets with large numbers of potential sellers, likely to be individuals or small firms, with non standardised goods or services being offered (that is, not uniform barcoded items such as books) and a small size of average transaction. The technology may be deployed in a market of multiple buyers, for example an exchange for sellers of household services, or a market in which there is only one buyer, for example a large employer who chooses to allow staff to sell themselves competitively into periods of work with as much flexibility as they wish.

Prior Art

It is known that “availability diaries” are used by those who sell the time of temporary workers. For example, software designed to automate temporary work agencies often features an online weekly record where a temporary is invited to select “available” or “not available” for the morning, afternoon and evening of a each day in the forthcoming week. Alternatively this data can be input by agency staff who have phoned a temporary worker in search of the information. Pioneers of this type of software include Bond Adapt, (www.bondadapt.co.uk) provider of recruitment industry automation and Tempz.com an online temporary work agency. These work diaries may be characterised as binary: for each given period a worker is either available or not. There are no degrees of availability. Similar availability diaries are used in services such as the booking of hotels and guesthouses where rooms are either available for a given night or not. Likewise plant hire rental and comparable markets are often based around availability diaries that are broadly binary.

Also known is employee or resource scheduling systems which are driven by “top down” scheduling. Typically these products (a) profile the skills and qualifications of a firm's individual workers possibly with weighting for their suitability for a variety of tasks (b) record a profile of the requirements for particular positions within the firm (c) allow input of numbers of staff required for particular functions at a particular time (d) store the rates of pay for each individual worker or each individual post (e) output the most cost-effective shift pattern for any given week based on specific requirements and factors such as staff holidays, requested days off and staff hours worked over a defined period (f) provide full management reporting and payroll information on the shift pattern produced.

U.S. Pat. No. 6,192,346 discloses a form of employee scheduling that allows individual workers to bid for time off with priority based on their seniority. Covering shorter periods of time, U.S. Pat. No. 6,587,851 explains technology for scheduling mobile technicians, such as field service engineers, so that they are matched with jobs with the minimum of travel. U.S. Pat. No. 6,683,947 outlines a means of scheduling call center workers based on the center's requirements while U.S. Pat. No. 6,594,470 demonstrates technology that allows management of call centers, including staff monitoring, to be carried out from a remote location. In a related field, U.S. Pat. No. 5,117,353 covers a system for running a temporary work agency that features a record of the individual's availability for each day of work.

The art includes Enterprise Human Resource Planning systems such as those offered by Rostima (www.rostima.com), Schedulesource (www.schedulesource.com), Shiftlogic (www.ad-opt.com) and Amcomsoft (www.amcomsoft.com). However, these systems typically (a) assume the individual is paid a rate set by the buyer with perhaps pre-determined incremental increases, for example for out of hours working, (b) reflect the employer's priorities not those of the seller or employee by for example offering ample opportunities for the employer to reduce their labor costs but little sophistication for the worker who wishes to maximise their income within the system (c) take little account of an individual's needs beyond allowing time off requests and holiday inputs.

Work availability diaries that offer more sophisticated choices to employees have emerged in industries where there are multiple factors affecting the times of work. For example, airline long-haul cabin crew rosters can factor in (a) an individual's willingness to spend stop-over time at a particular destination (b) their willingness to be away for the duration of a particular trip. This is achieved in systems such as Interbid by Carmen of Sweden, (http://www.carmen.se/) as used by British Airways and other carriers, by awarding staff a notional number of points for each scheduling period, The number of points may increase with seniority and allow workers to bid for flights they most want to work by “spending” their points. But the system typically requires staff to (a) work a minimum number of hours (b) accept at least some shifts they would rather not perform (c) be inflexible in the way they commit in advance to future schedules.

Software is widely used to manage individuals' diaries. U.S. Pat. No. 6,144,942 outlines a means for notifying users of events they have previously indicated to be of importance by a plurality of devices. For corporate personnel, U.S. Pat. No. 6,064,976 provides for a system that automatically updates a user's availability for meetings and other events with little user input. Similarly, U.S. Pat. No. 6,016,478 shows how technology can be used to facilitate the scheduling of group meetings with the optimum time for all participants discovered. U.S. Pat. No. 6,380,959 discloses a method for creating interactive online calendars such that video or animation can be used to present information.

Other forms of scheduling of individual sellers that are well advanced include the scheduling of taxis within a given area. Such systems typically require (a) a terminal in each car (b) a central controller which receives orders either direct from customers or from a human controller. Typical processes include (a) receiving a request for a cab (b) deciding on the most eligible taxi in the fleet based on location, input either manually by the driver or through a GPS transmitter, or a combination of location and recent lack of customers (c) informing a driver of his next transaction (d) receiving confirmation (e) updating cab location records. A market leader in this technology is Mobisoft of Finland (www.mobisoft.fi).

The ability to construct prices based on buyer demand is well known. U.S. Pat. No. 5,752,238 discloses a consumer driven electronic information pricing engine. U.S. Pat. Nos. 5,822,736 and 5,987,425 cover a variable margin pricing system that allows the pricing sensitivity of a retailer's goods to be established with pricing then constructed dynamically. Similarly, U.S. Pat. No. 6,076,071 disclosed a means of changing the prices in a virtual store inline with demand and advertising for each product. U.S. Pat. No. 6,684,400 describes a system that calculates the optimum price for digital information. U.S. Pat. No. 6,336,097 discloses a means of constructing large numbers of travel fares in real time based on matrices covering geographic areas that can be combined in multiple ways to arrive at an optimal price.

Thus individual sellers in the art tend to be either scheduled according to the priorities of a big buyer, with far less flexibility around the seller's needs, or scheduled according to binary availability on the assumption that all who are available at any given time are equally available. There is little opportunity for sellers to compete with each other through price or changing the terms under which they will sell. Although Enterprise software is predicated on considerable awareness of the complexities of a modern corporation there is little account taken of the complexity of individual seller's willingness to sell. Neither employee scheduling software or availability diaries in the known art can accommodate availability accompanied by conditions such as: “I will only work this evening if I can find a childminder once I know I have a booking”, “I'm not keen to work next weekend but I will if the weather is bad because then I am likely to be in more demand”, “I can only work on Thursday if my sister is working the same shift to provide the transport and my husband is not working so he can look after the baby”.

There are other drawbacks within the art. Sellers who undertake to complete transactions for which they are booked at times for which they have displayed availability might be purchased for a small percentage of that availability which then renders the rest effectively unsaleable for the much larger period they had had hoped to be working. Sellers have little means of promoting themselves or trying new patterns of selling. For example, a seller may wish to experiment with different pricing or an upgraded offering but progressively retreat to an offering more in line with typical market demand as the block of availability in question gets nearer if the signs are their experiment is unsuccessful. Sellers may wish to respond to events in related markets that they believe will increase or diminish demand in their own sector. Achieving any of this with a binary availability diary is extremely time consuming, relying on manual changing of inputs, if it is possible at all.

Because of these drawbacks there is currently a reluctance by sellers to commit to the inputs in an availability diary. Outside of employee scheduling processes or other systems where the seller (worker) has a pre-determined contractual obligation to the buyer (employer), sellers tend to prefer that their availability entries be used as a guideline while assignments are confirmed, and rates finalised, in a dialogue with a buyer or an intermediary. This is time consuming for both sides and inhibits the immediacy of purchase that allows buyers and sellers to make very precise decisions about market entry at the last minute.

There therefore exists a need for functionality that will allow any seller to have periods of “Conditional Availability”, that is offering units of sale which are only available dependant on an infinite array of parameters which might include:
Characteristics of a transaction for which they might be suitable
Market activity
The seller's own performance in the market
The seller's personal circumstances
Events outside the market, such as the weather or local events

Such functionality would be most useful in an environment where (a) sellers have access to detailed Market Overview information allowing them to see patterns of demand, supply and pricing in their markets in their area; they may wish to make market entry at a particular time dependant on this data (b) sellers operate in a market which penalises them, for instance with a downgrading, if they say they are available but they subsequently fail to fulfil purchases of their time or goods made on that basis. In such an environment it is particularly important that sellers are able to specify “I am only available if . . . ” at any time they choose.

### SUMMARY OF THE INVENTION

According to the invention, there is provided a transaction management system for managing the purchase of a product or service by a buyer from a seller, the system comprising:
a data store for storing seller data comprising, for each of a plurality of sellers, a seller identifier;
a program store storing processor implementable instructions; and
a processor coupled to the data store and to the program store for implementing the stored instructions, wherein the stored instructions comprise instructions for controlling the processor to implement a seller interface to receive seller offer data from a seller, the seller offer data including an availability record for a product or service offered for sale, the availability record defining a plurality of periods of conditional availability, each period of conditional availability having an associated set of conditions under which the product or service is or is not available.

By allowing for a seller to indicate periods of conditional availability in an availability record, the invention provides a flexible transaction management system in which sellers are more likely to indicate some form of availability.

Preferably, the data store is further for storing the seller offer data received from a plurality of sellers by the seller interface. Availability of the product or service during the periods of conditional availability is preferably dependent on data internal or external to the system.

Preferably, the seller interface is further implemented to receive a plurality of sets of conditions from a seller, each set of conditions comprising an availability rule. In this case, the data store is preferably also for storing the availability rules received from a seller by the seller interface. The data store may also store a plurality of predefined availability rules. The seller interface may then be implemented to facilitate construction of the availability record for a product or service by receiving periods of conditional availability associated with availability rules from the seller. Such an implementation provides a simple yet flexible mechanism for building the availability record.

The availability record for a product or service may define that availability in at least one period of conditional availability is dependent on a buyer purchasing at least one linked product or service. In this case, the at least one linked product or service may be offered for sale by at least one different seller, and the seller interface is further implemented to notify the at least one different seller that the products or services have been linked.

The availability record for a product or service may define that availability in at least one period of conditional availability is dependent on at least one linked product or service being available to the seller.

The availability record for a product or service may define that availability in at least one period of conditional availability is dependent on a purchase comprising less than a defined amount of the period of conditional availability. Alternatively, the availability record for a product or service may define that availability in at least one period of conditional availability is dependent on a purchase comprising more than a defined amount of the period of conditional availability.

The availability record for a product or service may define that availability in at least one period of conditional availability is dependent on a linked product or service not being purchased for the period of conditional availability. The availability record for a product or service may define that availability in at least one period of conditional availability is dependent on the seller's revenue or profit in a preceding timeframe.

The availability record for a product or service may define that availability in at least one period of conditional availability is dependent on a travel distance associated with the buyer from a preceding buyer location. Alternatively, the availability record for a product or service may define that availability in at least one period of conditional availability is dependent on a travel distance associated with the buyer from a current location of the seller. In this case, the system is preferably arranged to determine the current location of the seller based on signals received from a global positioning system device or a cellular telephone device.

The availability record for a product or service may define that availability in at least one period of conditional availability is dependent on a defined reduction in the availability of products or services in a defined market. The availability record for a product or service may define that availability in at least one period of conditional availability is dependent on a defined rise in the price of products or services in a defined market.

The availability record for a product or service may define that availability in at least one period of conditional availability is dependent on the seller having sold a defined number or value of linked goods or services by a defined time before the period of conditional availability begins. The availability record for a product or service may define that availability in at least one period of conditional availability is dependent on a linked product or service being unsold at a defined time before the period of conditional availability begins, the linked product or service being a larger quantity of the product or service offered for sale.

The availability record for a product or service may define that availability in at least one period of conditional availability is dependent on a defined increase or decrease in the price of the product or service.

The availability record for a product or service may further define a plurality of periods of unconditional availability or unconditional unavailability.

The seller interface may be implemented across the Internet. The seller interface may alternatively or additionally be implemented across a cellular telephone network. In this case, the availability record may be based on SMS text messages received by the seller interface across the cellular telephone network.

The stored instructions preferably further comprise instructions for controlling the processor to implement a buyer interface to:
receive a purchase enquiry from a buyer, the purchase enquiry including a required period of availability for a product or service;
output seller offer data for a plurality of sellers able to provide the product or service for the required period of availability; and
receive a purchase request from the buyer accepting an offer.

Preferably, the buyer interface is implemented to only output seller offer data for products or services that are conditionally available if the associated set of conditions are met. The system may be arranged to determine whether the set of conditions are met at a predetermined time before the associated period of conditional availability. Alternatively, the system may be arranged to determine whether the set of conditions are met when a purchase enquiry for the products or services is received form a buyer.

The buyer interface is preferably implemented over the Internet.

The seller interface may be further implemented to indicate the current availability of the seller's products or services during periods of conditional availability. The seller interface may also be further implemented to indicate the potential availability of the seller's products or service during periods of hypothetical conditional availability. In either of these cases, the seller interface may be further implemented to indicate the availability of other sellers' products or services. As well as availability information, the seller interface may also be implemented to indicate price information.

The system is for managing the purchase of products or services by one buyer from a plurality of sellers. Alternatively, the system may be used by several buyers and may operate across several underlying markets.

According to a second aspect of the invention, there is provided a method for managing the purchase of a product or service by a buyer from a seller, the method comprising:
storing in a data store storing seller data comprising, for each of a plurality of sellers, a seller identifier; and
implementing a seller interface to receive seller offer data from a seller, the seller offer data including an availability record for a product or service offered for sale, the availability record defining a plurality of periods of conditional availability, each period of conditional availability having an associated set of conditions under which the product or service is or is not available.

The method aspect may have corresponding features of the system aspect.

The invention also provides a computer software product arranged to cause a computer to execute the above method and a computer readable recording medium having encoded thereon at least one program for performing the above method.

As shown in FIG. 5a, Availability Server 500 is connected to, or forms an integral part of, at least one marketplace in which a plurality of sellers transact with one or more buyers. The sellers list their willingness to sell specified goods or services at a particular time, at that time or in advance of that time. Said marketplace may already have a facility to allow sellers to list times when they are willing to sell such as Seller Availability Record 431b described earlier. This is modified to either (a) allow itself to be replaced by the present invention for sellers who wish to interact with Availability Server 500 (b) take in seller's standard availability and times of non availability but additionally flag periods of time when a seller is conditionally available and their listing for any given transaction must be subject to assessment by Availability Server 500.

The present server allows any seller to allocate a conditional willingness to sell to a block of future time. A wide range of data can be accessed and analysed to see if an individual seller's conditions for availability for a particular transaction at a particular time have been met. If they have not, the seller is deemed not available and may not be displayed as an option for the buyer.

A user of the present invention is able to create a plurality of rules that can then be applied to any block of future time they wish. Rules specify “At this time the seller is only available if . . . ” Examples of rules, expressed colloquially might be: (a) “. . . prices in my market are well above average” (b) “. . . my husband and I together have earned less than $400 in the last week in the marketplace” (c) “. . . the buyer is a registered corporation rather than a small trader”. Individual rules can be merged if there is no contradictions between them, for example a user could apply all three conditions above to a block of availability, thus their rule covering those hours becomes: “At this time I am only willing to sell if prices are high, our household budget is down and it's a corporation that want me to work”.

Each user runs an availability diary in which they list future periods of availability to sell with, if they wish, a rule attached to each period. This is stored within Enhanced Availability Store 560. A skilled user may choose to create their own rules by defining (a) one or more sources of data anywhere within Availability Server 500 or an underlying marketplace (b) the data to be extracted from said source (c) any calculations to be performed on said data (d) a comparison figure above or below which the user is to be deemed available. Additionally there needs to be verification to protect a user from basing a rule on sensitive data, such as another seller's sales record, without permission.

Rather than creating rules from scratch, it is easier for users to work with pre-formed rules to which they need only add their personal thresholds for availability. Thus Availability Rules Store 550 contains a table of pre-formed rules each of which is made up of (a) wording and selections of thresholds which are offered to users who wish to add this rule to their portfolio (b) the process steps, as outlined for user created rules above, which must be followed to establish if a seller is available at any given time when this rule is in force (c) any actions required to protect other users or otherwise ensure the integrity of the market before this rule can be applied by a user.

Rules fall into three broad categories:
Search requirements: availability is dependent on a search carried out when a purchase request, for which the seller may be available, is received at a time when the seller is displaying conditional availability. Availability Search Module 520 will then ascertain whether the requirements for availability are currently met. For example: “Our fork lift truck is only available for hire at this time if the loadspace in trucks market in the underlying system of marketplaces has risen by more than 10%”. A search can lead to an action or the construction of a package for the buyer. For example “I am only available at this time if one of my approved assistants is also available and booked as part of the same transaction.”
During-availability sweeps: Seller Monitoring Module 540 checks repeatedly throughout the given period of availability that the conditions are met. For example: “I am only available to work if there is a signal from my mobile phone at the time.”
Advanced sweeps: Sweeps Module 535 checks the progress of a particular transaction, or the state of the market, at a specified time, for example “My 500 bales of hay will be available for sale on Saturday, if they have not been bought by Friday then I want them automatically broken into smaller lots”.

As well as applying a rule to a period of availability a user may specify additional conditions for their availability. These include (a) a change in pricing, for example “if I am listed as an option under this rule add another 10% to my price” (b) a change in the selling parameters, for example “at times when I am available under this rule I am only willing to work within 5 miles of my base postalcode and only on jobs with at least 48 hours notice”.

Additionally, a user can specify actions to be carried out by Availability Server 500 at times when, or after, they have made a sale under the terms of conditional availability. They might for example decide “if I am going to work on Wednesday evening, I want to then cancel my next 4 hours of unsold availability”. They can also change the way they are (a) contacted by the system to advise them of a sale, perhaps demanding additional means of contacts during periods when they are only going to have their goods or services sold in unlikely circumstances (b) accepting assignments (c) priced for future assignments.

Sellers can view reports on their availability patterns that may include “what if . . . ” scenarios reporting sales they may have made had they applied different availability rules.

Availability Server 500 works for sellers of either goods or services. A seller of services, or hirer of goods, inputs availability into a grid of hours, or other units of time, for each week. A seller of goods must also interact with inventory management software that will require they specify the quantity they have to sell. Thus, their availability has two components attached to each potential sale. “I have 50 bundles of flowers for sale and will act on orders between 10.00 and 12.00 on Saturday and between 16.00 and 18.00 on Sunday.” The management of inventory is well known in the art and is not described in detail in this document. Where a seller is offering goods the present invention will check with associated inventory software that the seller has not exhausted the goods they have to sell and, only if there are still stocks to meet a buyer's needs, list the seller as an option for a particular buyer.

The descriptions of components and processes above and in the rest of this document are illustrative only. It will be clear to those skilled in the art that the architecture required could be achieved in an infinite range of ways.

The facility to apply multiple “types of availability” to future periods may be used only at its simplest level by a user. An individual worker for example may simply decide “I will only be available to work in the evening if an assignment is within 2 miles of home and I get an extra 20% compared to the prices I would expect during the day”. However, assuming they would not be willing to make an unqualified commitment to selling at this time, by using the present invention they have (a) brought increased availability into the market (b) ensured pricing within the market more accurately reflects the seller's willingness to sell under any given conditions (c) by increasing the range of offerings for a buyer's needs, made the market both more competitive and better able to respond to short notice purchasing.

Responsiveness to short notice purchasing benefits all users in a marketplace. Buyers are able to make precise purchases at the last moment at a competitive rate rather than booking in advance, when their needs are still unfocused, to be sure of meeting their requirements. In a market in which many buyers routinely make last minute purchases sellers are able to routinely make their own market entry decisions at a late stage if they wish.

As users become comfortable with the idea of different types of availability applied to any block of time when they might potentially be available to sell they are likely to use the facility with increasing sophistication. A seller who has never previously considered night work might begin to input availability that specified “I am available to work night shifts for a trial week if (a) I get at least 5 days notice (b) my normal rate is doubled (c) the weather forecast for that period is good (d) I have not found work in the daytime that week. This ease of experimentation allows the market to expand, perhaps establishing night piecework options in sectors in which it had never before been a realistic option for buyers. Without this sort of facility finding a temporary worker to do a one off night shift would have been too time consuming, entailing a process of phoning round seeking to cajole a qualified worker into complying with the buyer's needs with no idea of the price at which they would fulfil the need.

Assuming the underlying marketplace allows immediate purchasing, a buyer can simply input their requirements for a night worker and see if anyone has chosen to be available, whatever their terms. If only a handful of sellers chose to list in this way prices are likely to remain high. If the underlying market offers users an overview of evolving demand, supply and pricing patterns in their area then night work hiring could attract more sellers, each with their own conditions for availability and pricing will increasingly reflect the willingness of sellers to provide for the changing needs of buyers.

A truly sophisticated user of the present invention might never list a period of non-availability. Instead they have increasingly strict controls, with increased prices, applied to periods when they would rather not sell and actions to be applied after a transaction to ensure they get the breaks they need. They would thus be interacting with the market on entirely their own terms yet putting themselves in the most competitive position to take advantage of trends in demand and supply.

### BRIEF DESCRIPTION OF THE DRAWINGS

FIG. 1 shows a completed buyer input screen within a known online marketplace defined by an ability to take in a buyer's requirements and immediately construct options specific to his needs based on broader inputs from any number of sellers;

FIG. 2 illustrates an exemplary screen returned by such a marketplace in response to the buyer input in FIG. 1;

FIG. 3 is a schematic illustration of the communications links required for this known marketplace and which can form the basis of the system of the invention;

FIG. 4 represents the system architecture within the Application Processor 306 and Datastore 307 for the system of FIG. 3;

FIG. 5a shows a possible relationship between Availability Server 500 and one underlying marketplace;

FIG. 5b illustrates one embodiment of the architecture required within Availability Server 500;

FIG. 6 contains a potential table of wording and selections for pre-formed availability rules such as might be stored within Availability Rules Store 550;

FIG. 7 accompanies FIG. 6 and shows a table of processing actions accompanying each of the sample pre-formed availability rules; this information is also stored within Availability Rules Store 550;

FIG. 8 illustrates a screen, generated by Availability Management Module 515, that allows a user to create their own version of pre-formed rules;

FIG. 9 is indicative of the table of an individual seller's rules stored within Seller Database Extensions 555;

FIG. 10 shows one embodiment of a screen through which a user may specify periods when they will be available to sell and apply any one of their rules to a period of availability;

FIG. 11 is indicative of the grid of availability for one user for a week that is stored within Enhanced Availability Store 560;

FIG. 12 flowcharts the process of performing an availability search as potentially carried out by Availability Search Module 520;

FIG. 13 illustrates the table of availability blocks that is assembled as part of the above process by Availability Search Module 520; and

FIG. 14 shows a potential screen for reporting to a seller on the way they have been displayed to buyers as a result of their availability instructions over a given timeframe.

### DETAILED DESCRIPTION

Description of the Architecture

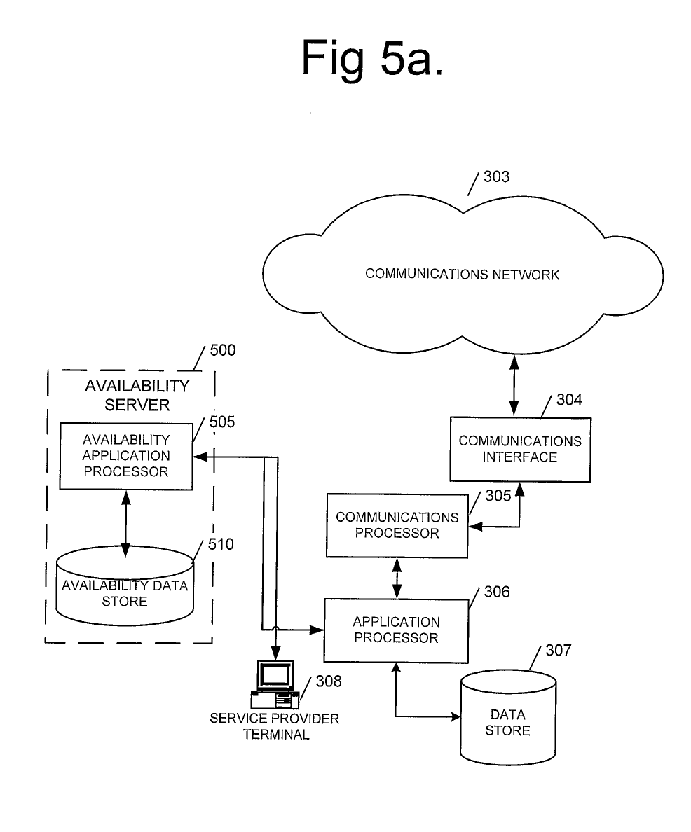

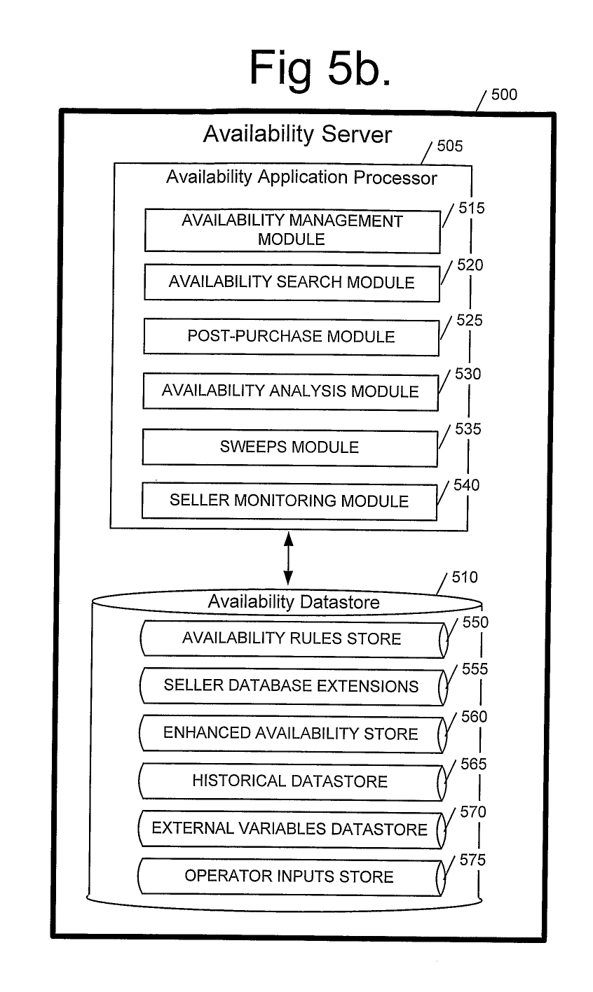

As illustrated in FIG. 5b, Availability Server 500 contains Availability Application Processor 505 which contains the following modules:

515 Availability Management Module: allows sellers to select the types of availability they wish to offer and input periods of controlled availability into the server.

520 Availability Search Module: searches any sellers for a potential sale who have “conditional availability” to establish whether the parameters they have set qualify them for a particular purchase request. This module is also able to check with inventory software, as known in the art, on the stocks of goods a seller has remaining.

525 Post Purchase Module: implements any change of instructions selected by a seller who is purchased under the terms of “conditional availability”, this might include how the seller is to be contacted or any changes to their future willingness to sell as a result of obtaining a sale under their terms of conditional availability.

530 Availability Analysis Module: allows sellers to see the consequences of their Conditional Availability in terms of the buyers' requirements that they matched and those they missed, it also allows new sellers to model various availability options based on historic market data. It is able to trigger seller search and price construction in the underlying marketplace to run data from past transactions with the addition of hypothetical seller data for a seller who wishes to model the likely effect of changes in their availability.

535 Sweeps Module: carries out advance sweeps of data within the system and over-rides entries in the seller database on the instructions of a seller who wishes to re-sell their commitments, for example because required numbers of purchasers have not been met.

540 Seller Monitoring Module: carries out during-availability sweeps, for instance checking that a given user is contactable or active on their specified computing device or their location as reported by a GPS style device.

Availability Datastore 510 contains the following records:

550 Availability Rules Store stores templates of pre-formed rules which users can personalise for setting up their own conditions of availability. Information is input from Service Provider Terminal 308.

555 Seller Database Extensions contains an extension to Seller Database 431 for any user who wishes to offer conditional availability, it stores the terms of each individual trader's various conditions of availability.

560 Enhanced Availability Store contains an extension to Seller Availability Record 431b, or replacement of that record, for each seller who wishes to interact with the present invention, it stores the days/hours when each user is available subject to their conditions being met plus for each unit of time (half hour for example) a base postalcode for the area where they are to be available at any given time (by default, the seller's base postalcode), the times when availability was input and a record of the hours for which they are booked to work.

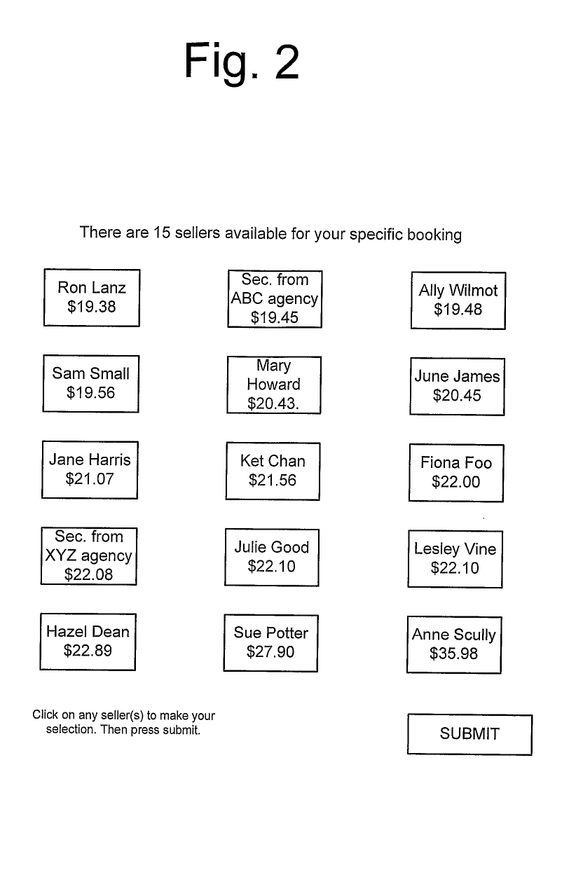

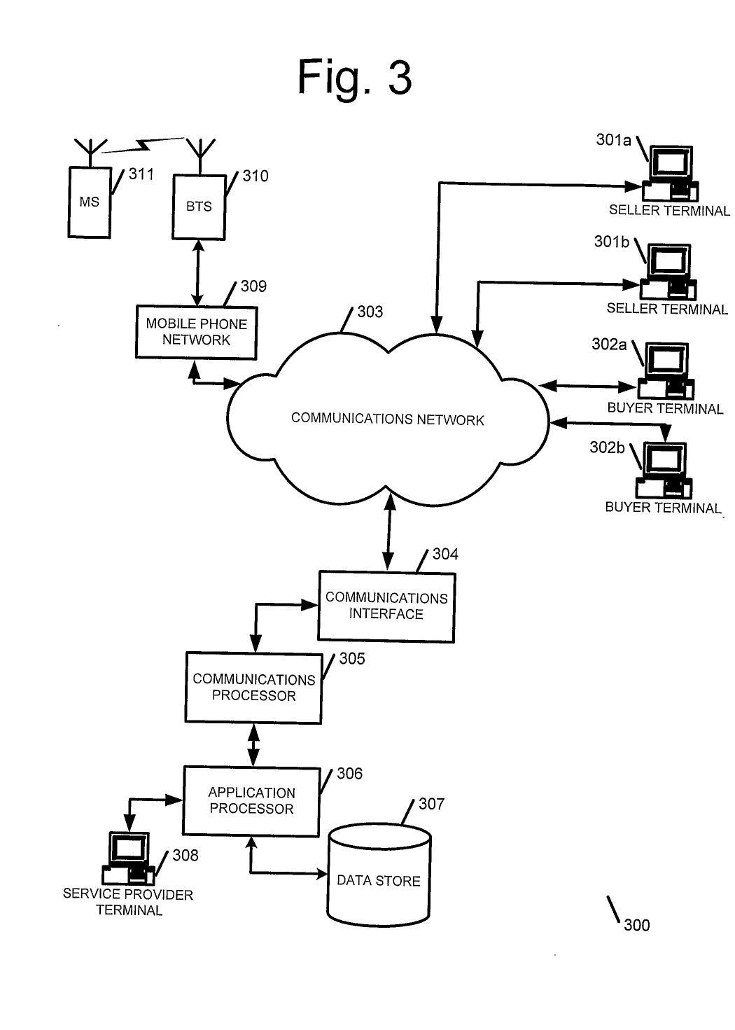

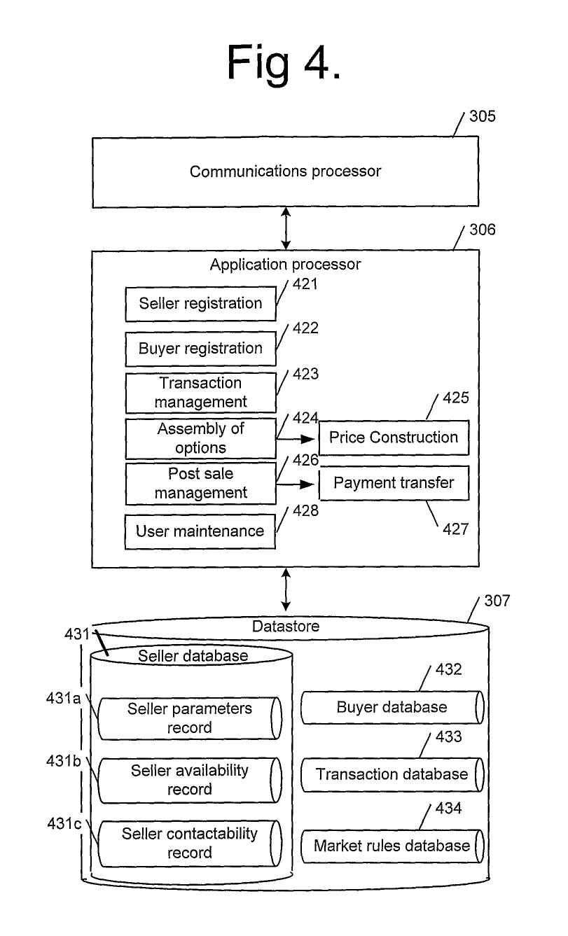

565 Historical Datastore stores the details of every seller offered to a buyer, how their price was constructed, the buyer's requirements that triggered the search and the price of each option every time the screen represented in FIG. 2 is generated, this is used for seller availability analysis. This module also archives availability records from Enhanced Availability Store 560 once the time of availability has passed.

570 External Variables Datastore extracts or accepts data from external sources that may be used by buyers to determine whether they are willing to sell, said data may include for example weather forecasts or timetables of local events. The range of transfer protocols available for such information intake are well known to those in the art and include systems such as RSS (Really Simple Syndication).

575 Operator Inputs Datastore holds market operator instructions covering, by way of example, the frequency with which sweeps to ascertain a seller's locality are to be carried out.

Overview of Availability Rules

Whether a seller is available at any particular time is determined by their availability diary stored within Enhanced Availability Store 560. Any seller who wishes to use the facilities of the present invention is able to establish rules governing their Conditional Availability which enables Availability Management Module 515 to set up a record in Seller Database Extensions 555.

A seller may have an infinite number of rules governing their Conditional Availability stored on their record within Seller Database Extensions 555. Each rule can then be applied to any block of future time of that user's choosing. For example; “next Thursday between 18.00 and 22.00 I am available to work subject to my rule 17”. An individual's rules might include options specifying they will only work if, for example (a) they have missed their personal income targets (b) they can purchase something in an adjoining market they themselves need to complete a potential transaction, a minicab journey to a place of work for instance (c) the number of sellers in their chosen market sectors is below average at the time of conditional availability. By default, Availability Server 500 will assume a seller who is available under the terms of their conditional availability is to have their standard parameters for sale and price construction as stored in Seller Database 431 applied.

The application of each rule is defined by the seller's inputs. Thus, in the three examples above, Seller Database Extensions 555 can not assess whether the seller is available at a particular time without (a) a record of their personal target figure and a timeframe which can be compared with their earnings, as stored in Seller Database 431, for that timeframe (b) a specification of the purchase on which their availability is conditional (c) the timeframe for calculating an average and the percentage below that at which the seller is willing to enter the market.

Thus, any rule for conditional availability is stored in terms of: (a) the relevant data sources within the system for locating the data on which an assessment of whether the seller is available will be made (b) the precise data to be extracted from each source (c) any calculations or comparisons between data to be performed (d) the threshold figure above or below which the seller is to be deemed available.

Sophisticated users may wish to set up their own unique availability rules by specifying all details required to construct their own version of the process outlined above. This can be done by means of a screen generated by Availability Management Module 515 offering Selection Boxes that allow a user to choose (a) the databases to which the system has access from which information for assessing availability is to be drawn (b) the columns from within their selected databases from which information is to be extracted (c) the row within the database that governs the selected information (d) any calculation to be performed on the data (e) the threshold for comparison above or below which the seller is available. For example, a seller of industrial storage space may want to establish the rule “we are only available to buyers who have spent more than $10,000 in this market in the last 4 weeks”. Their inputs with reference to the above definitions would be as follows (a) Transaction Records (b) purchases in selected markets (c) the present potential buyer (d) total all purchases in last 4 weeks (e) if figure is less than $10,000 I am not available. (Because this instruction requires access to data other than the seller's own or that is publicly available, this rule would not be implemented by Availability Management Module 515 without the advance permission of buyers, possibly obtained at the time of registration.) Obviously, such a rule could also be presented as a pre-formed option stored within Availability Rule Store 550 and market operators may choose to monitor the types of rules being set up by sophisticated users and ensure they are then made available as templates to all users.

Likewise, a sophisticated user can input instructions on price calculation by defining any parameters against which a purchase request may be measured and indicating his preferred percentage mark up or mark down for each. He can then attach those pricing instructions to any period of availability or any rule.

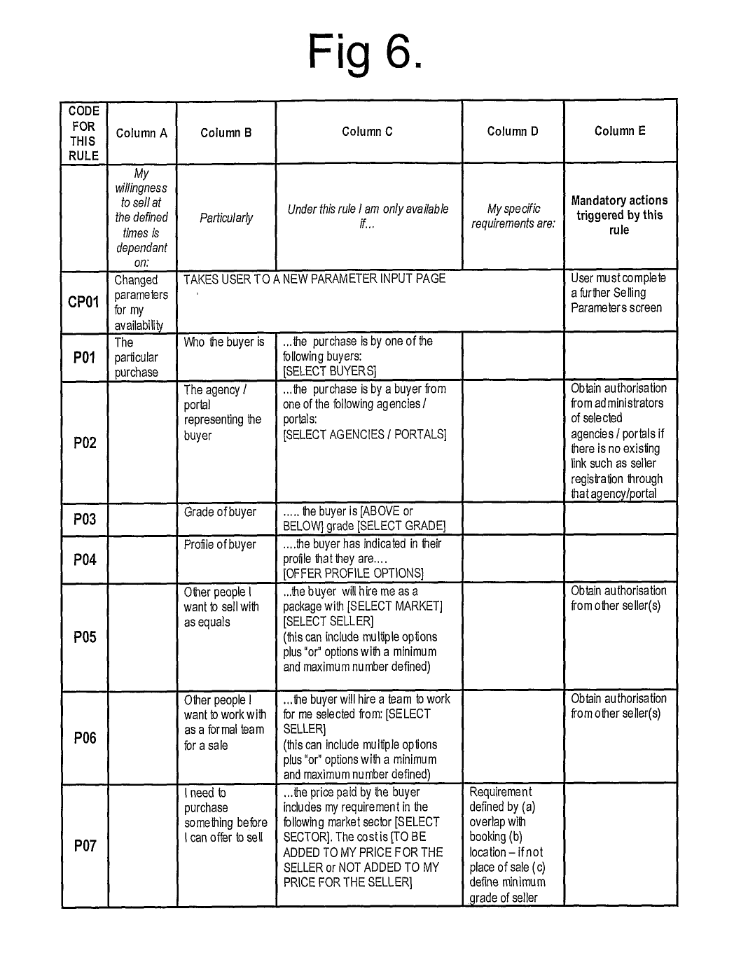

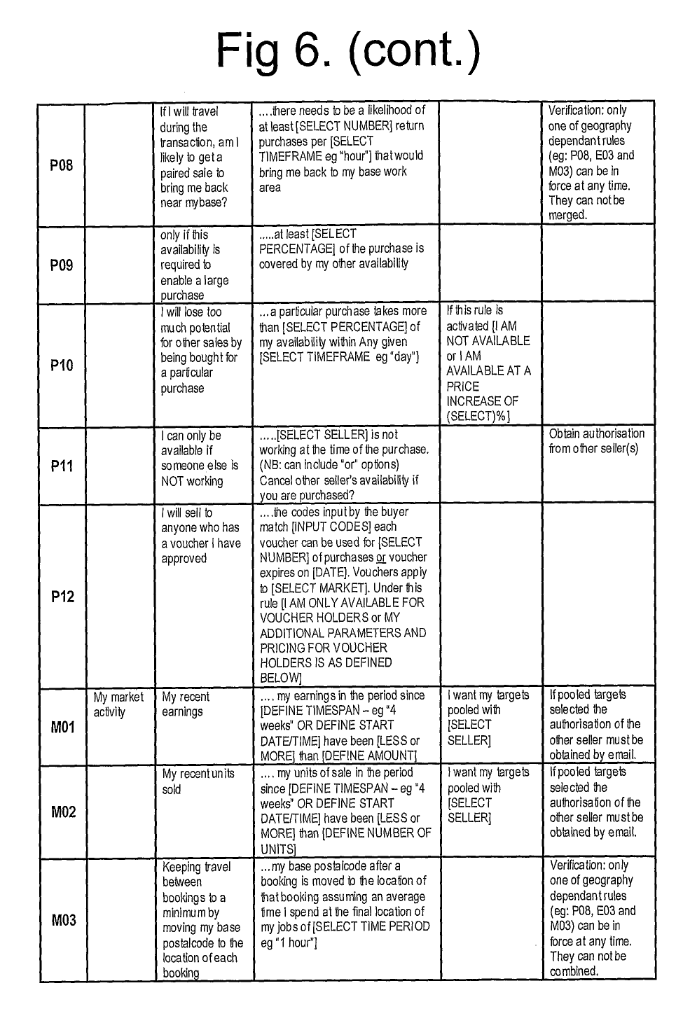

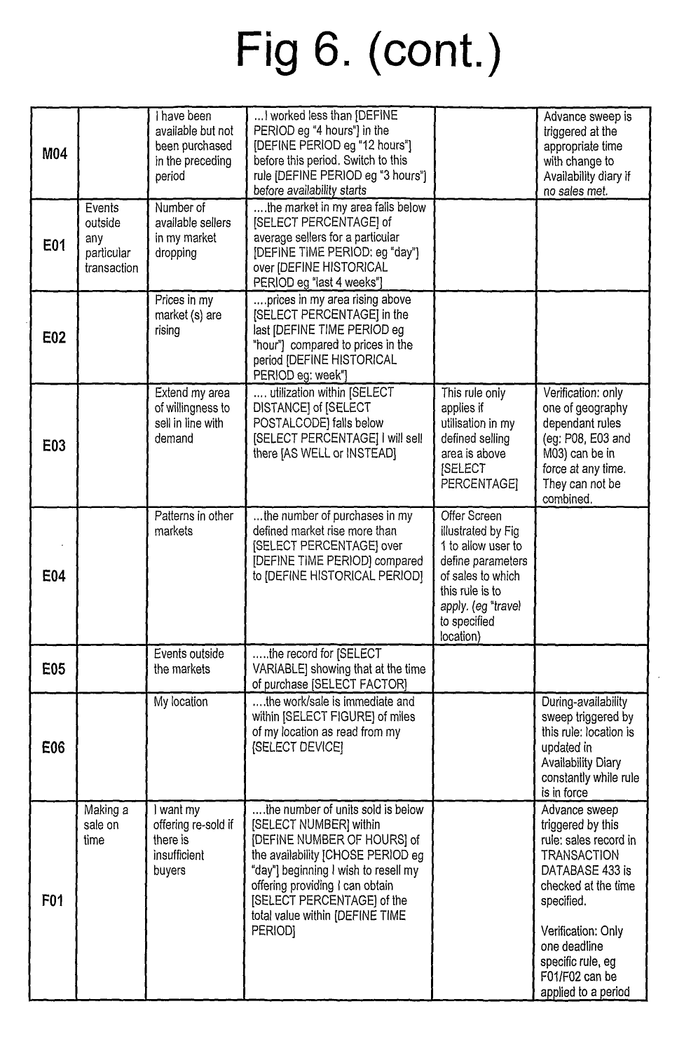

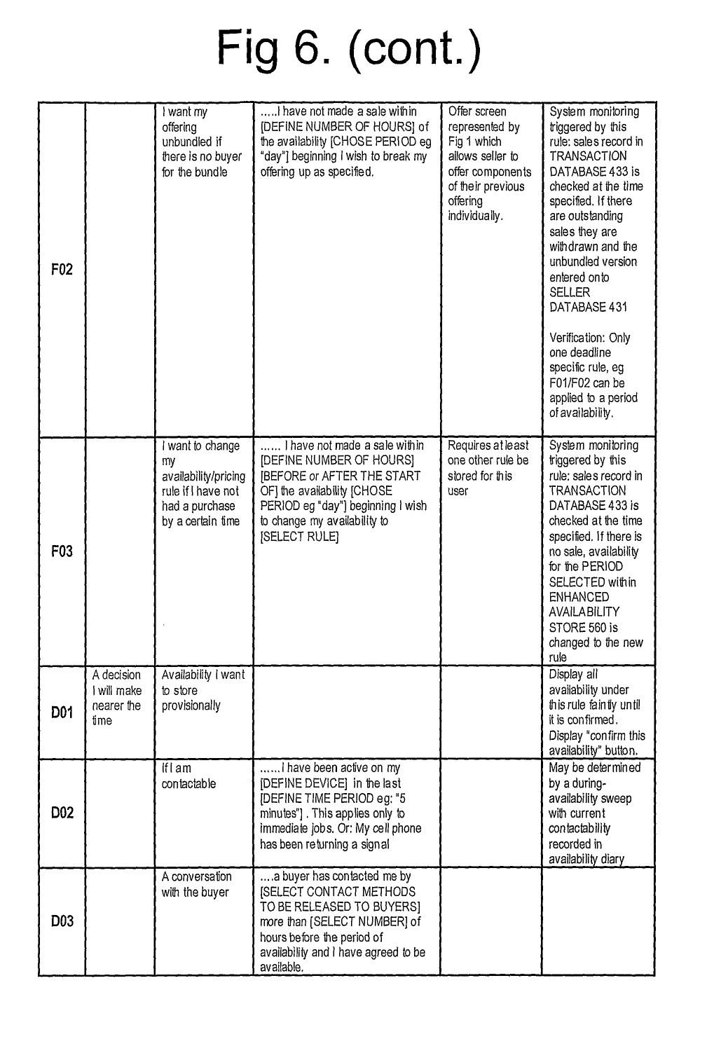

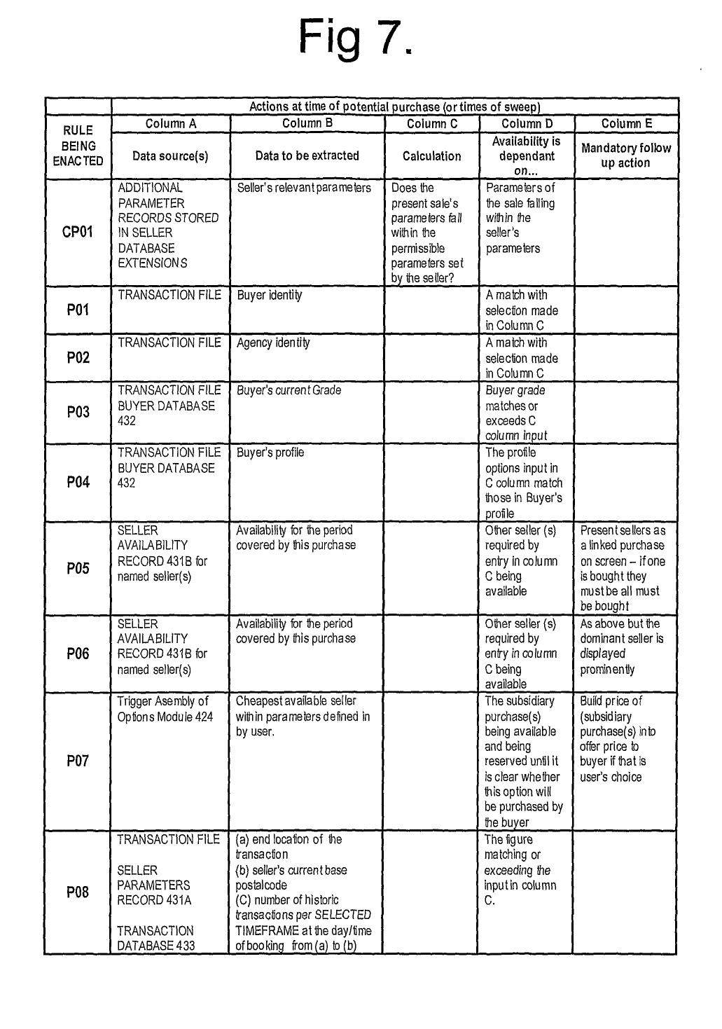

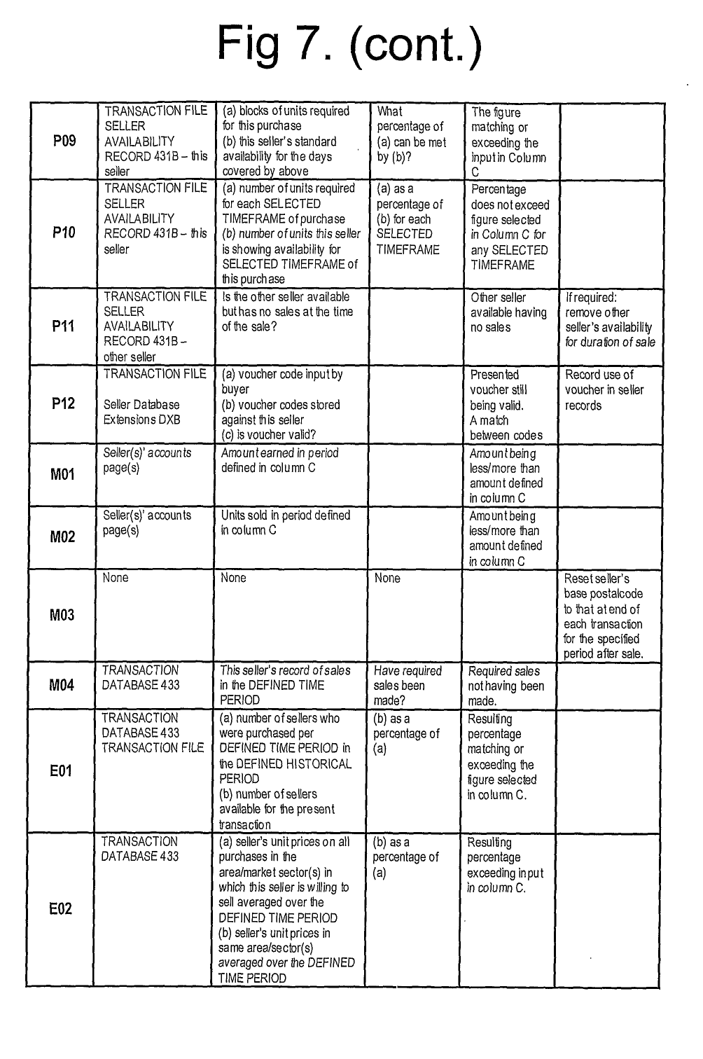

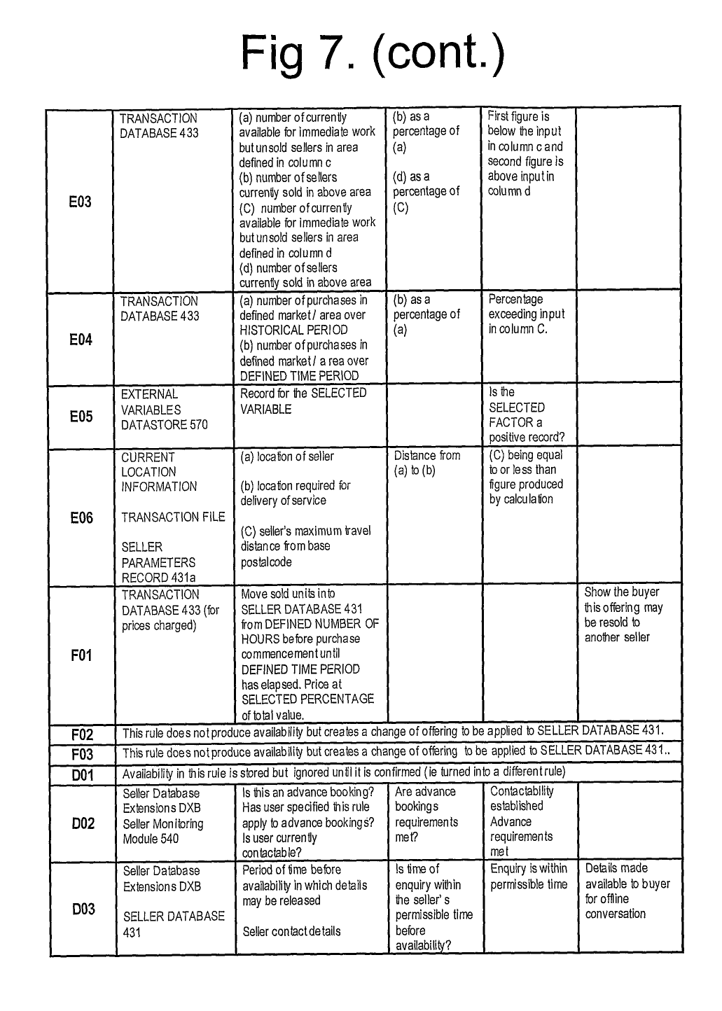

However, most users are likely to benefit from a menu of pre-constructed types of availability to which they need only add their choice of inputs defining the conditions under which the rule is to be applied in their case. Some examples of pre-constructed rules will now be described with reference to FIG. 6 and FIG. 7.

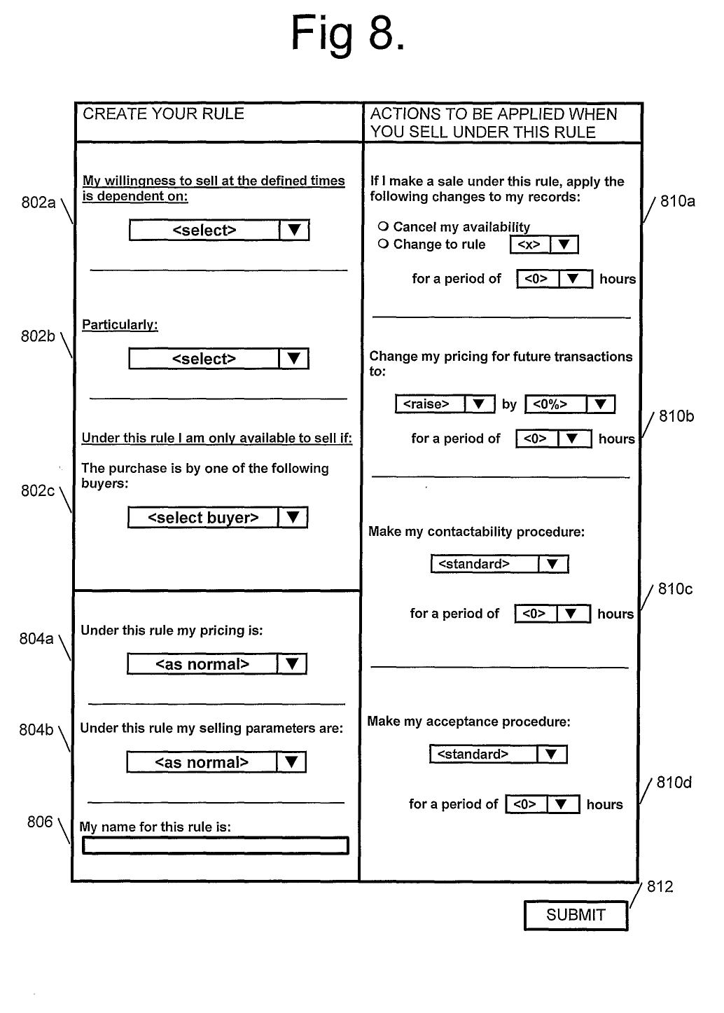

FIG. 6 illustrates a table that might be stored within Availability Rules Store 550. It is designed to populate the drop down boxes represented in FIG. 8 by sections 802a, 802b and 802c. Thus a user calling up the screen represented by FIG. 8 must first select an input for section 802a, the options are shown in Column A of FIG. 6 and the user must select one. That action ensures all the entries in Column B pertaining to the Column A selection are then offered in section 802b. Once that selection is made, any text and inputs required in column C appear in section 802c. In some cases there may be further clarification required which is summarised in Column D and might appear in a pop-up window. By completing the process just described a user is establishing their own parameters for application of a particular rule, the rule has a reference within Availability Rules Store 550, such as the code shown in the left hand column of the table in FIG. 6.

Turning now to FIG. 7. This lists the (a) data sources (b) data to be extracted (c) calculation required—if any (d) threshold figure to determine availability (e) mandatory follow up action to any application of the rule. This data, also stored in Availability Rules Store 550, is given for each rule in FIG. 6 using the Code for each rule, again in the left hand column.

If a rule has been constructed uniquely by a user (a) there is no involvement by Availability Rules Store 550 in the process (b) it is given its own unique code at the time it is input directly into Seller Database Extensions 555.

The menu of availability types contained within Availability Rules Store 550 covers many useful options in multiple marketplaces. A brief explanation of each pre-formed sample rule in FIG. 6 will now be given with reference to the code for each rule in the left hand column. Examples of how a particular rule might be used by a seller are given in quotation marks.

Examples of Availability Rules:

CP01 enables a seller to be available with different parameters from those in their standard availability. The inputs screen for this rule is the same as for standard availability but allow additional sets of parameters to be stored. A user may have input rules defining the terms on which they will sell, possibly in the way envisaged for GEMs type markets as outlined earlier. Such parameters may include, (a) geographic area in which they will sell (b) period of notice with which they will accept jobs (c) minimum or maximum units within one sale they will accept, for example the shortest shifts they will work. Any of these factors may carry pricing rules. The present option for conditional availability allows a user to create any number of sets of parameters which they can attach to periods of availability. (“At these times I will work within a smaller geographic area than I have specified for my standard availability and only on shorter shifts and with a 10% increase in my price”).

P01 to PO4 cover characteristics of the buyer that must be met for a seller using each particular rule to be available. PO1 allows a seller to only be available for specified buyers at the selected times (“there are times when the only buyer I will work for is Acme Company”). Similarly PO2 allows a seller who is registered on the system through an agency to set up times when they are only available to be sold through that particular agency's channel to the marketplace. In a market in which buyers are graded according to their track record of reliability PO3 ensures a seller is only displayed to buyers within certain parameters (“In the overnight accommodation market my rooms are only to be displayed to buyers of Grade 4 or above at the times I apply this rule.”) If buyers are given a profile in which they can define themselves from selections then a seller can use PO4 to ensure they are only displayed to buyers who have made the appropriate selections in their profile; (“I only let my rooms out to buyers who have signified they are vegetarians”).

PO5 and PO6 allow a seller to specify they will only be available for sale if they are bundled with at least one other seller. Before either option is activated in Seller Database Extensions 555 the other seller(s) named are emailed and asked to confirm their willingness to be sold in this way. PO5 assumes all the grouped sellers are equals and displays them on the screen represented by FIG. 2 as an inseparable offering if both have initiated a rule or with one only made available if the other has been selected for purchase if only one of them has initiated this rule. (“At these times I am only available for work if my sister is also working the same shift because I rely on her for transport”). Alternatively rule PO5 can be applied to a separate market, for example an operator of video equipment who specifies she is only available for sale if she is purchased together with one of her specified video editing suites. In this case she might be displayed to buyers as an option but with an icon signifying there must be an additional purchase before a contract can be completed: alternatively, the two options could be constructed and priced as one for the buyer.

PO6 allows the sale of pre-formed teams with a leader, for example in a market for home decorating. (“I will only be available for work if Bob Jones is hired as my assistant for the transaction.”) This ensures the primary seller can be held responsible for the work of a team assembled immediately based on multiple availability diaries for perhaps a half day's work; he has signified his willingness to supervise the others in his team in advance.

PO7 is designed for sellers who could only be available for a particular assignment subject to a purchase by the seller in another market. (“When this rule is in force I am available for periods of work only if a baby-sitter who meets all my requirements can be booked in the childcare market to come to my home with the cost added to my fee to the buyer.”)

Rule PO8 is for delivery drivers, minicab drivers and so on who input an area within which they will travel as part of their availability inputs. It enables them to specify geographic areas to which they will additionally travel as long as there is reasonable likelihood of selling the return journey. (“I am based in Central London but will travel up to 200 miles outside as long as there are at least 10 return journeys an hour from that location to London averaged over the day.)

A problem with binary availability diaries is that a seller can lose a large sale that they could have obtained with a small change in availability. For example; a sale for 35 hours of work for which the seller is available for only 34 of the required hours will cause them to be rejected as an option in most current systems. Using rule PO9 a seller can specify for example “I am available within this block of time if time covered by this rule makes up no more than 10% of a total purchase”.)

A related problem with availability systems in the art is that a seller who has agreed to be available at the times they are displaying availability is vulnerable to a purchase that takes out a small segment of availability while rendering the remainder virtually unsaleable. For example, someone who is available for 10 hours of work each day of Monday through Friday finds they have been booked for five one hour shifts at lunchtime each day, thus ruling out the possibility of a full day's work anywhere else. P10 protects against this by allowing a user to raise their price, or be rejected as an option, if a particular purchase is going to remove less than a given percentage of the period of time covered. In a further embodiment of this rule a seller might be able to specify blocks of time at the beginning or end of a period of availability that may be purchased without the rule being invoked while protecting the middle of a period which, if taken by a short booking, does the most damage to future sale prospects.

P11 is designed for groups of two or more sellers where one must not be working at the specified times. Again it requires authorisation confirmed by email before entering the record in Seller Database Extensions 555. (“At this time I am only available for work if my husband is available—but not working—because one of us has to look after the children. If I am booked, cancel his availability for that period.”)

Sellers in electronic marketplaces can promote their services in a variety of ways, including the awarding of codes, often called vouchers, to potential buyers or to intermediaries authorised to pass them on to potential buyers. P12 allows this to be turned into specified times of availability. (“I am a hairdresser and have given out codes to potential clients at a fashion show, I am available at the specified times at different pricing to anyone inputting one of my codes.”)

M01 to M04 allow sellers to have their availability determined according to their personal patterns of sales activity in the underlying marketplaces. M01 allows a target for income to be input and a timeframe within which it is to be achieved. If it has not, at the defined times the seller is available. (“If I haven't made $800 in sales in the last four weeks I will be available to work this weekend.”) M02 applies similar logic to the units of sale, for example hours, over a defined period. Both can be pooled targets, for example a husband and wife sharing a target for household income through the underlying marketplace. In a further embodiment the seller may be able to select a time point at which the availability is to be inserted if they have not achieved their goal.

M03 allows a seller to have the base postalcode, for which distance related pricing is calculated, moved to the location of each transaction in the defined period. (“I am a plumber, if I get a job in a certain area I then want to be cheapest for other jobs within that area at the time I am due to finish the job.”) This rule is dependant upon (a) an extended version of the user's weekly availability grid shown in FIG. 11 to allow a postalcode or map reference to be attached to each unit of availability, by default it is populated with the user's base location until overwritten by this rule (b) that Asembly of Options Module 424 takes the user's base location from the availability grid illustrated by FIG. 11 rather than from a more static record within Seller Parameters Record 431a. Rule M04 is designed for users who wish to add additional availability during which they will only work or sell if they have not made a significant sale in an earlier period. (“I will be available to work tomorrow evening only if I've done less than 2 hours work during the day.”)

Rules E01 to E06 allow a seller to be available depending on events outside of a particular transaction. E01 ensures a seller is only available at particular times if the number of sellers in one or more of the markets in which they have registered to sell falls below average for a specified period. (“I will put my vehicle into the car hire market if the number of cars available to buyers falls below 75% of the average for this day of the week.”) E02 applies the same logic for rises above average price levels.

E03 is again aimed at mobile sellers such as minicab or delivery drivers. It allows them to extend the defined geographic area in which they will sell to encompass an adjoining area if that adjoining area has high rates of sales relative to the number of available sellers. E04 allows a seller to come into the market based on patterns in adjoining markets. (“If bookings for coach travel to Scarborough on a Friday rises above average I will put my rooms in Scarborough into the overnight accommodation market for that weekend because clearly a lot of people are coming here for the weekend.”)

E05 utilises data within External Variables Datastore 570, allowing a seller's availability to be determined by external factors. (“If there is an event listed for the exhibition centre near my home when I have activated this rule then I will put my rooms into the overnight accommodation market.”)

Rule E06 is intended to work with devices such as mobile phones or GPS enabled personal organisers that are able to identify the device's geographic location as a map reference. (“I will be out around Boston all day and will do any job with immediate start that fits within my parameters so long as it is less than 0.25 of a mile from my location at the time.”)

Rules F01 to F03 are designed for sellers who wish to automatically change their offering to the market if sales are poor. FO1 is for sellers of fixed cost services reliant on multiple buyers who wish to re-sell a part-sold offering to another, more economical seller. (“I am offering 52 seats on my coach from Boston to Lincoln next Friday, if I have a contract with less than 20 passengers for that journey 24 hours before departure I want to see if I can find another provider for them, providing it costs me no more than an additional 5% on top of what they will pay me, so that I can then try and sell my 52 seats on a more popular route.”) In the example just given, if the threshold is not achieved, it may be that the passengers are transferred to another operator making the journey at the same time, or a more economical minibus is hired for their journey. Where this kind of re-selling is a condition of availability Enhanced Availability Store 560 ensures that fact is displayed to buyers at the time of purchase.

F02 applies similar logic to breaking up an offering for sale into smaller units. For example an accommodation provider may offer 10 rooms on a conference basis but, if they remain unsold 7 days before the chosen date, they are to be sold separately.

Rule F03 allows sellers to experiment with their market offering. It simply triggers a switch within Enhanced Availability Store 560 to a separate availability rule if there has been no purchase by a given date. At its simplest this rule enables a seller to drop their price as a period of availability gets nearer. But it can also be used, by attaching additional rules, to widen the area of work or change the willingness to accept certain kinds of bookings or change any other parameters discussed in this document. (“If it's Thursday and I haven't been booked to work on Monday, I want to drop my base price by 15%, show willingness to work up to 10 miles from home and accept evening working”.)

Finally; D01, D02 and D03 allows a user to input provisional availability which is stored by the system but which they decide about later. D01 is any availability that the user wants to input but not confirm yet. (“I will be available at these times if it turns out I don't need to resit my driving exam.”) D02 relies on technology well known to those in the art that establishes whether a user is currently contactable, for example by checking for a mobile phone signal or for recent activity on an online or wireless enabled computing device. Using this rule a seller can signify willingness to work immediately just by turning on their cell phone or other communications device.

D03 is intended to cover times when the user's willingness to fulfil transactions is dependant on a dialogue with the buyer. Selecting this options ensures that at the times covered a buyer is shown the seller as a faint option but is able to click for a screen containing the seller's chosen contact details. This rule may be most effectively used in conjunction with other rules that narrow the range of buyers for whom the seller is available. (“During these hours, I am only available to work for Acme Corporation or Grade 6 buyers but only if they call me and I accept first.”) After a conversation the seller must input the work period in their availability diary which generates a contract to be sent to the buyer for online confirmation. A block of availability governed by this rule within any wider period of availability covering a potential transaction will require that the seller is called regarding the entire transaction. In a further embodiment Enhanced Availability Store 560 might store a record of all the buyers who were shown a seller's details under this rule, thus a seller can check whom has been given their details through an appropriate screen at any time. Additionally, the system may make a charge, to buyer or seller, determined by a figure stored in Operator Inputs Datastore 575 for each buyer to whom the details are released.

The rules outlined above are indicative of the range of potential rules which can make availability conditional on (a) any data within a related system of marketplaces (b) any data Availability Server 500 is able to read from an external source. It will be clear that many other examples could be offered. Thus, Availability Rules Store 550 contains a plurality of pre-formed rules for conditional availability that can be selected by any seller.

Setting up Conditional Availability Rules

A seller creates their version of a pre-constructed rule for Conditional Availability using a screen like that represented by FIG. 8. It is generated by Availability Management Module 515 drawing on Availability Rules Store 550 and will now be described.

The process by which a user selects the rule which they wish to add to their personal list using sections 802a, 802b and 802c has been described above. As an example, the text shown by FIG. 8 assumes rule P01 is being input.

Within section 804 the user is able to stipulate that different parameters and pricing be applied to sales made under this rule. Section 804a allows a recalculation of their price, for example an increase by 10% of the price they would otherwise charge. This is factored into the process run by technology such as Price Construction Module 425 when a sale is under Conditional Availability. Likewise, section 804b allows the user to define particular parameters of sale covering for example; travel distance to complete a transaction, minimum period of notice or minimum length of shift to be applied to purchases made under this rule. Within section 804b users have a choice between (a) their standard availability parameters (b) any other sets of parameters they have entered into Seller Database Extensions 555 and named for example using rule CP01 (c) a new set of parameters they wish to create and attach to this rule. The later choice brings up a parameters page requiring inputs for completion. The information in this section is used as the source data for Assembly of Options Module 424 in any search on a buyer's requirements for which the present user is covered by Conditional Availability.

Section 806 requires a user to name their version of the rule, this is then used to enable them to identify the rule when it is applied to blocks of availability in their diary.

All the information input into this screen is used to establish a new rule against the user's identity in Seller Database Extensions 555. Additionally a user can, if they wish, input preferences that cover the period after they have worked or made a sale under the terms of a particular Conditional Availability rule. For example, a seller who has worked for a period only because the market in which they sell was particularly short of sellers in their area at the time might wish to stipulate that they cancel all availability, or change to a more restrictive type of availability, for a specified period at the end of that block of availability.

Section 810a allows a seller to specify changes to his availability diary within Enhanced Availability Store 560, or other availability diary, to be automatically implemented once a sale has been made under the present rule. Section 810b likewise allows future potential transactions for a given period to include a price mark up that is factored into Price Construction Module 425 for any transaction during that period.

A seller may also wish to change the way they are contacted about transactions for which they have been purchased during or after a period of Conditional Availability has resulted in a sale. It may be, for instance, that they would like an automated phone call from the system when they get a job because they may be paying less attention to their incoming messages after a period of unexpected work. Thus, section 810c might present them with contactability procedure options including, in order of how demanding on the user the option is deemed, with least demanding first: (a) standard (b) automatic phone call to alert user to a message (c) call center call with an agent ready to read out details of the job (d) messages sent to multiple devices (e) message sent to additional users who will inform the seller of his newly notified assignment. The cost of these options may be added to the seller's price displayed to each buyer and then subtracted from the final fee by Payment Transfer Module 427. In a preferred embodiment any option selected here may also be applied to transactions during the period of Conditional Availability to which it is attached. Thus a user is able to set a very high threshold for their willingness to work and know that, in the unlikely event that all their conditions are met, the system will take additional steps to ensure she receives notification of the sale.

Section 810d allows the user to change their acceptance procedure for transactions over a given period. A user might be able to choose from (a) standard acceptance procedure (b) automatic acceptance—that is, they will permit the system to automatically and instantly accept any job meeting all their parameters without their confirming it (c) a commitment to accept within a given timeframe, whatever, the length of time the system allows, 5 minutes for example. This means they will be taking on any contractual liability which is within all their parameters with no option whatsoever to decline or clarify instructions, it may be that only users with a solid track record are allowed to engage this option. In a preferred embodiment any option selected here may also be applied to transactions during the period of Conditional Availability to which it is attached.

Clicking on Submit button 612 enters all the information on this screen onto Seller Database Extensions 555 and generates a new rule against the user's identity. It will thus be clear that a user can input any number of variants on a rule, for example having a rule that they will enter the market when the number of sellers in their chosen market falls below 75% and another specifying they will enter the market when the number of sellers in their area falls below 50%. They can apply either version of the rule to any block of future availability they wish.

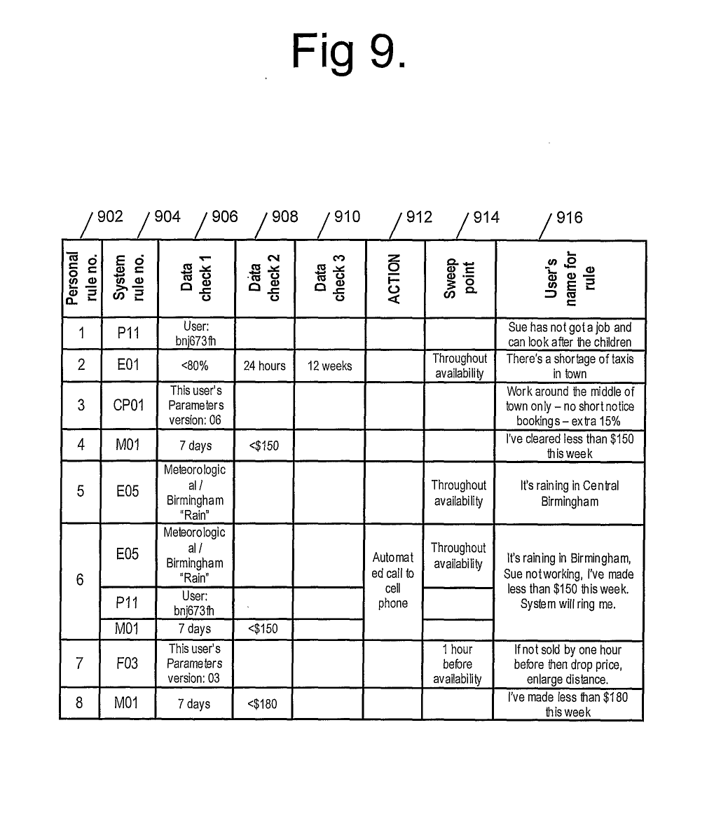

FIG. 9 shows in overview an example of the record for one seller held within Seller Database Extensions 555 as a result of the seller's interaction with the screen just described. It uses by way of example rules that may be input by a seller in the Minicab journeys market. Column 902 gives that version of the rule a number for this seller. Column 904 identifies the rule within Availability Rules Store 550, if any, on which this user's rule is based. Columns 906, 908 and 910 contain the user's selections taken in from the screen represented by FIG. 8. Column 912 records the actions accompanying that rule taken in from the right hand column of the screen represented by FIG. 8. Column 914 stores times of any sweeps of data that must be triggered because Availability Rules Store 550, or the user's own inputs, shows that the availability is dependant on factors that are not (a) specific to a particular transaction (b) stored within External Variables Datastore 570. That is, the conditions for availability require checking either (a) at a given period before the block of availability, for example “I want to un-bundle my offering if it has not been sold 24 hours before the block of availability” (b) constantly during the period of availability, for example “I am only available for work at this time if I am contactable”. Column 916 stores the user's freetext entry giving a name to this version of the rule.

Sellers are able to apply multiple rules to one block of availability. A set of combined rules is shown in row 6 of the data table represented in overview by FIG. 9. The process for achieving this will be explained later in the next section.

In an alternative embodiment of the process described above, actions to be taken after sales during a period of Conditional Availability could be separated from the availability rule under which the seller worked or made a sale. This is achieved by taking the right hand column of FIG. 8 and splitting it into a separate screen which allows any user to establish an infinite number of post-sale actions by the system, each of them given a name or number either automatically or by the user. For any period of availability under any rule the user can then define actions to be applied to their record within Seller Database 431 for a chosen period thereafter.

Inputting Availability

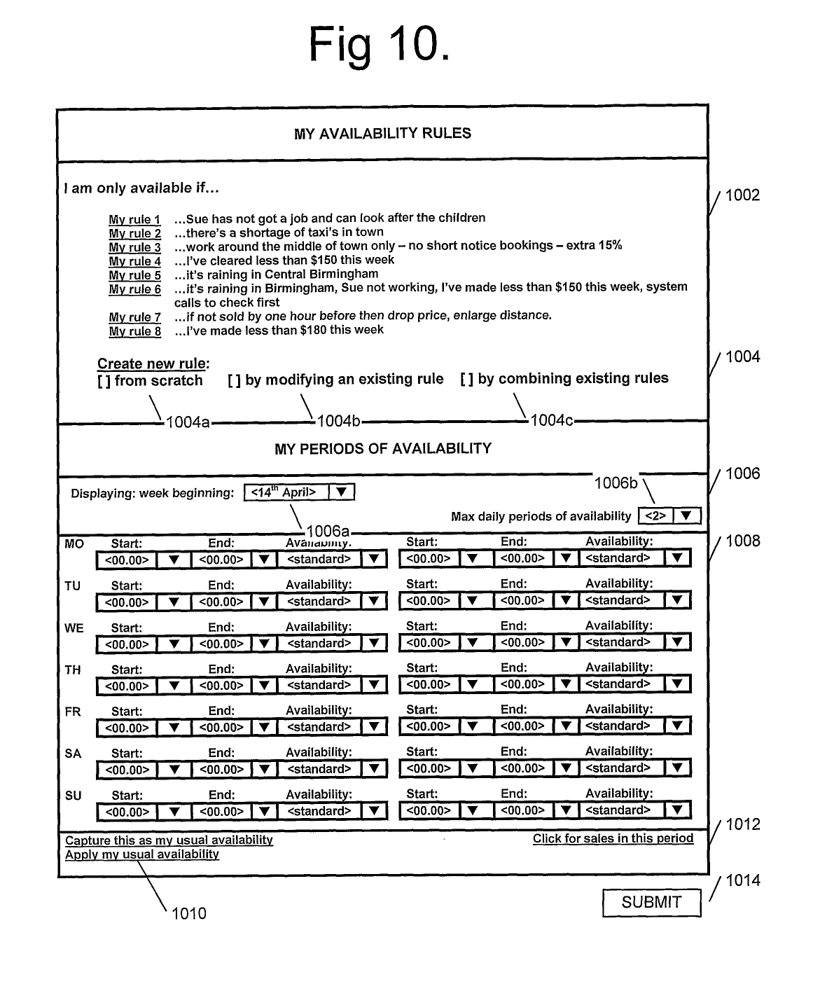

A user who has set up at least one availability rule is able to apply their personalised availability to any period of time in the future from the next hour (or other unit of sale) to the maximum period allowed for inputs by the system as stored in Operator Inputs Datastore 575. They input availability using a screen generated by Availability Management Module 515 like that represented in FIG. 10 which reflects, by way of example, the screen that might be shown to the user whose rules are illustrated in the table in FIG. 9.

Section 1002 lists the present user's current rules as read from their record in Seller Database Extensions 555. Section 1004 allows the list of rules to be increased. Selection box 1004a brings up a blank version of the screen represented by FIG. 8. Clicking on 1004b brings up the list of existing rules with a request that the user select one and click Submit, the screen shown by FIG. 8 is then delivered already populated with the inputs for that rule, any one of which can be changed to create a slightly amended version. 1004c is only displayed to users with more than one rule created. Again it brings up a list of the existing rules for this user stored on Seller Database Extensions 555 and asks that he highlight the ones he wishes to merge into a new rule.

When merging rules, the user must specify whether the merged rules are to work (a) in combination or (b) independently of each other. A combined rule requires that each of the component rules must be satisfied for the seller to be available. In the case of independent rules, only one of them need be satisfied, this creates two options for the search (a) the rules are applied to the transaction in the order they were assembled at the time of merging by the seller and the first one to be satisfied is applied (b) all component rules are searched and the one that creates the most favourable terms for either the buyer or seller is applied, the decision being made by the seller. For clarity, (a) is the embodiment assumed in this document. Merged rules can themselves be merged to create further combinations.

Once he has highlighted more than one rule and clicked “Submit” the user is shown a modified version of the screen represented in FIG. 8. In place of sections 802a, b and c it lists the user's names for the rules to be modified and requires him to name the new rule as well as, if he wishes, stipulating accompanying pricing and selling parameters plus, if he wishes, any actions to be applied to his records after this new rule has resulted in a transaction.

For clarification it should be explained that a user can merge multiple versions of one rule. Thus a user may have perhaps five different versions of rule P01 (“I am only available for named buyers”) with different pricing or selling parameters applied to each. They can have all five rules activated for the same block of availability with their price and selling parameters determined by which version of the rule is activated, that is; which buyer is making the enquiry. Likewise rules that dictate progressive changing of a user's parameters for sale and pricing can be merged into a sequence so that, using for example rule CP01 and setting different activation times, a seller can get progressively cheaper and more widely available as a block of availability approaches. This could be particularly useful to sellers of perishable goods.

In an alternative embodiment of the merged rules function, Availability Management Module 515 might sort the pricing, selling parameters and actions required for each of the rules being merged and then apply the most beneficial to the user of each from any of the rules that form the basis of the new rule. That is, the new rule has (a) the highest price construction rules of any of the three rules (b) the most restrictive inputs for any one of the selling parameters for any of the rules (c) the most demanding of the actions after a sale. In a further alternative embodiment all the stipulations could be merged so (a) the pricing compounds, adding any mark up specified for each rule (b) the selling parameters become the most restrictive of any input for anyone of the parameters for any of the rules (c) all actions after a sale that are specified for any of the base rules are carried out with duplicate instructions ignored. However, a drawback to these two embodiments of the merged rules function is that either could easily create unintended consequences for the user when merged. Therefore the preferred embodiment is that the user treats the merged rules as a new stand alone rule in terms of specifying accompanying data or, alternatively that the first of the rules to be merged by the user sets the pricing instructions, selling parameters and actions after a sale for the new merged rule. As a further alternative merged rules could apply to different conditions within a potential transaction. Thus a user could set up rule PO1 (“I will only be available for nominated buyers”) with pricing and parameters attached and rule P05 (“I only sell if I am bundled with another named seller”) for the same period. The user can specify that rule P01 over-rides rule P05 when a nominated buyer is making the enquiry.

Sections 1006 and 1008 of the screen represented by FIG. 10 allow the user to input availability for a specific period. 1006a allows him to select a week starting from the present week through to, perhaps, 12 weeks in the future. The actual figure is stored in Operator Inputs Datastore 575. If selecting the current week, obviously no availability can be entered for a time which has passed. That is, the earliest availability that can be input is the present time.

Having selected a week, at 1006b, the user stipulates the maximum number of periods of availability that they wish to enter a day. This brings up section 1008 with that number of inputs for each day of the week. By default all inputs are empty, that is; the seller is assumed to have no availability until he has input a willingness to sell at certain times subject to certain rules.

Within section 1008 the user can input times when he will be available subject to the rule of his choosing. For example, for Monday he might select Start: 08.00 End: 14.00 Availability: Rule 2. Then add another period in the evening which might be Start: 18.30 End: 22.30 Availability: Rule 1. For convenience, having input a week of availability the user is able to, using the upper line at section 1010, have those inputs stored against his record in Enhanced Availability Store 560. By clicking on the lower line at section 1010 he can then have those inputs instantly populate section 1008 for any future week.

As a user is purchased by buyers their availability record is updated by Post Sale Management Module 426. If the unit of sale is a block of time, the units of availability that have been purchased are removed, along with any required for “buffering”, that is; time required to travel to the place of transaction and back again at either end of the transaction if appropriate. This is likely to be achieved by a table of time allowed for each mile of travel between the seller's base postalcode and the place of transaction. All purchase details are recorded on Transaction Database 433. By clicking on 1002 the user can view details of their purchases for the present week. When all or part of a period of availability has been bought an icon appears against that period in section 1008 signifying that it may not be withdrawn; only any unsold remaining availability within that period may be cancelled. Otherwise, a user is free to change the times or rules of their availability at any time. Finally, Submit button 1004 stores all the inputs in section 1008 within Enhanced Availability Store 560. If the unit of sale is physical goods the inventory management software covering this seller's stock is updated and the seller's availability remains unchanged unless they have stipulated otherwise.

Thus, it will be clear that Enhanced Availability Store 560 contains a record of future availability for each user. This may be stored as a series of grids such as that illustrated by FIG. 11. For simplicity, this illustration assumes the unit of availability is an hour, in reality it may be 30 minutes, 15 minutes or in some very fast moving markets such as answering telephone services, 5 minutes. It also assumes the market is purely time based, if physical goods were being sold supplementary rows of information would link to the appropriate record in inventory management software.

Column 1102 lists the days of the week. Row 1104 covers every unit of availability during the day. The grid is therefore able to store the rule numbers which currently govern that user's availability at any time in that week. “S” in a box signifies Standard Availability, a blank box signifies no availability.

There are a number of alternative embodiments to the screen represented by FIG. 10 which will be disclosed.

Combined rules embodiment: in an alternative version of the present invention the user may be able to attach multiple rules to a period of availability without first merging the rules to create a new rule. Thus a user's grid as exemplified in FIG. 11 might show in one box that the user is available at that time subject to their rules 3, 4 and 8. This allows the user greater flexibility but has the disadvantages of (a) enabling unintended consequences in the merging of rules as discussed earlier (b) requiring verification against possibly contradictory or incompatible rules at the point of assembling options for a sale rather than at the point of compiling a new rule.

Abbreviated code input embodiment: a user may wish to update his availability at a time when he is not near a computing device. Once the grid, as shown in FIG. 11 is understood as the store of his availability he can do this with an abbreviated code. Thus by sending a message via Communications Processor 305 that (a) identifies the user (b) establishes his right to change his record in Enhanced Availability Store 560, through knowledge of a password for instance (c) contains instructions for entering a period of availability, the user is able to update his availability at any time. For example, he may instruct the system to accept calls from his mobile phone number and automatically enter his password. Using a Short Message Service (SMS) facility on a mobile phone he might then text: APR 14-09.00-18.00-8. This updates Enhanced Availability Store 560 to show that on April 14^{th} his availability will be 9.00 in the morning to 18.00 subject to his rule 8. In a further embodiment, a user may be able to set up very simple codes for remote input into his availability diary such as “sending the letter A to Communications Processor 305 from my cell phone number signifies I am available under my rule 1 for the next half hour”, “sending the letter B means I am available under rule 1 for an hour”, and so on.

Graphic display embodiment: the creation of colour coded displays is well known to those in the art. A user might for instance be able to view a version of the grid shown in FIG. 11 which displays, at a glance, colour bars for different periods of the week with each bar covering a time for which the user is available and the colour signifying the rule under which they are available. In a further embodiment the colour coded display could be used as a means of inputting availability with the user able to select boxes on the grid using a pointing device in ways that are known to those in the art and likewise selecting the rule which is to be applied to the newly created block. Periods when the user had been purchased might then be displayed in a neutral color such as gray.

The Advance Sweeps Process

Certain availability rules, for example F01, F02 and F03 might require action by Availability Server 500 ahead of a period of availability starting. Rules, such as F01 for example, that specify “if X has not been achieved by time Y then the terms of my offering change to Z” require a sweep to assess whether X has been achieved. This is performed by Sweeps Module 535 triggered by a “sweep required” record with specified time for any user stored in Enhanced Availability Store 560. These records are put in place by Availability Management Module 515 when (a) Submit button 1014 in the screen illustrated by FIG. 10 is clicked (b) any rule input in section 1008 of said screen contains a “sweep required” flag as for example listed in column E of the table shown in FIG. 6. The time when a sweep is to be triggered is based on the user's inputs, for example “24 hours before the block of availability starts”.

Thus, Sweeps Module 535 constantly sweeps a variety of data sources and changes sellers' offerings, or the parameters under which they will sell, within Seller Database 431 or Enhanced Availability Store 560. These changed inputs are then searched as normal by functionality such as Assembly of Options Module 424 that is seeking to match sellers with a buyer's needs.

Assembly of Options for a Buyer

It should now be clear that (a) Enhanced Availability Store 560 contains a record of availability for a plurality of sellers at any specified time with links to inventory management software when goods, rather than time, are being sold (b) Seller Database Extensions 555 contains details of the rules under which each seller is available if they signify Conditional Availability for a particular unit of sale (c) the present invention is able to interface with at least one system of marketplaces in which a buyer may input details of a desired purchase and be shown a list of sellers who are willing to fulfil the transaction.

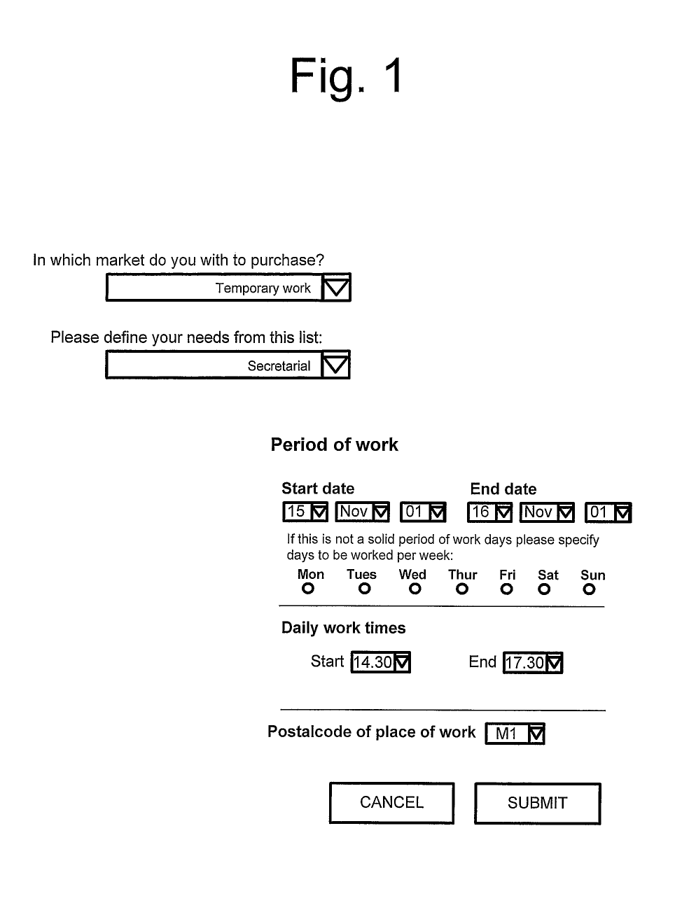

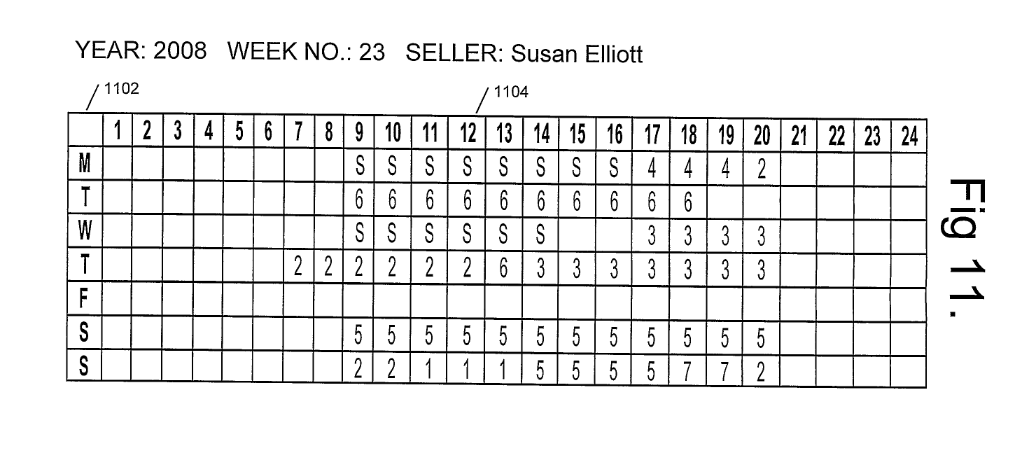

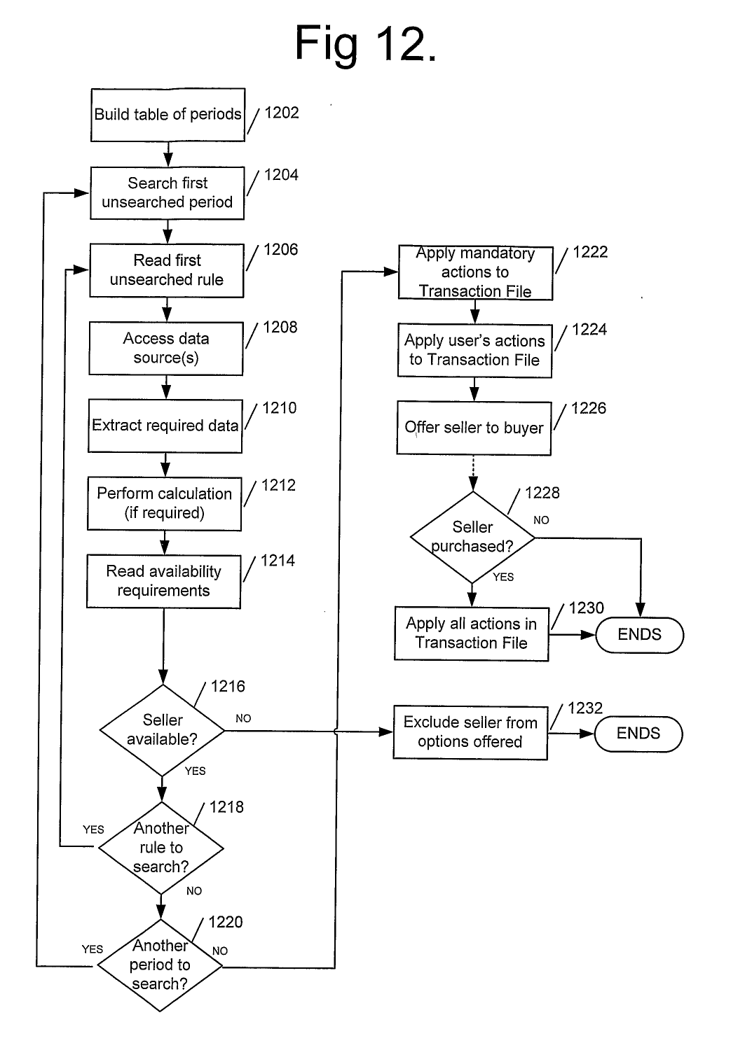

The process by which a buyer is matched with sellers, any of whom may be only conditionally available, will now be described with reference to FIG. 12. This process, run by Availability Search Module 520, would in the case of “GEMs” type markets described earlier, work in conjunction with Assembly of Options Module 424. Thus a buyer has input a requirement for purchase, possibly using a screen like that represented by FIG. 1. Assembly of Options Module 424 is able to immediately reject any sellers who are (a) not qualified for the market in which the purchase is being made (b) not available for all or part of the transaction period or not available with the buffering required for travel to the place of transaction (c) not contactable (d) not in the locality required for this buyer's needs (e) lacking the confirmation from inventory software that the seller has sufficient stocks to meet the buyer's need if the sale involves goods. The process now described is triggered when Assembly of Options Module 424 detects a qualified, contactable seller, potentially available to complete a transaction in the required geographical area but with at least one block of Conditional Availability within the units of sale required to complete the transaction. Said units can be blocks of time, for hire of a person or object, possibly involving a journey or may be physical goods such as produce or ingredients. The later may be registered by linking individual blocks of inventory to individual periods of availability. Using this facility a seller can ensure certain blocks of inventory are associated with a particular period of availability.

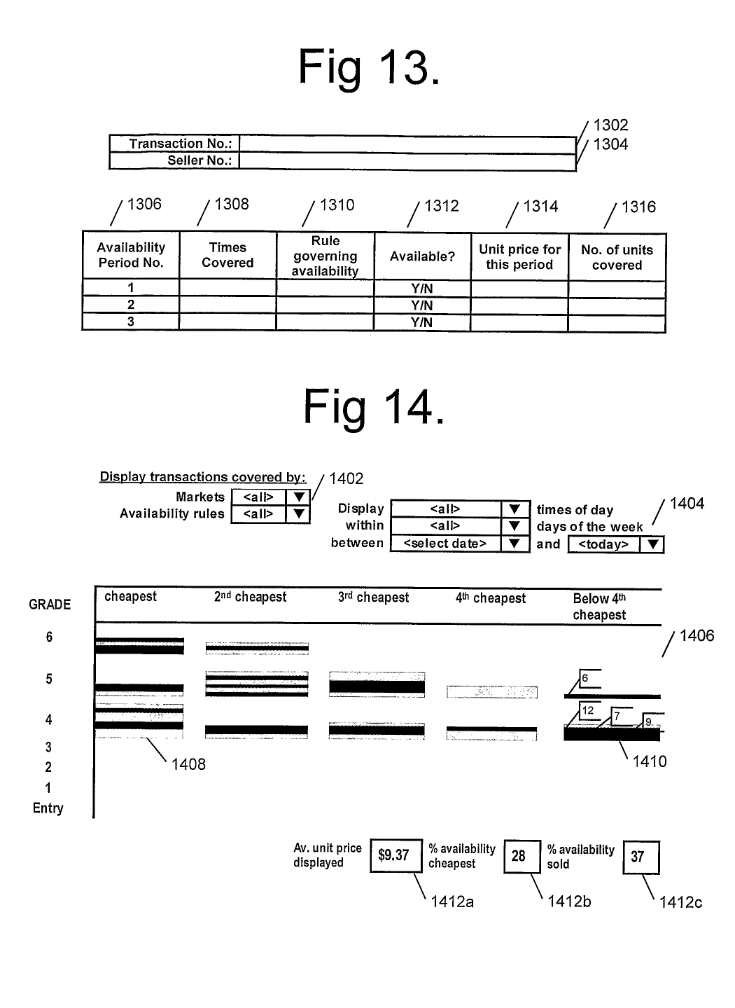

At step 1202 Availability Search Module 520 compiles a list of all the blocks of Conditional Availability or standard availability covered by the present purchase request for the first seller to be searched. This may produce ten or more blocks each with its own rule to determine whether the seller is available for this particular transaction and how the price is to be constructed for that block. The structure of such a table is illustrated in FIG. 13 where rows 1302 and 1304 identify the transaction and the seller being searched, column 1306 is the further number given to each block of availability which must be satisfied for this seller to be available for this purchase, 1308 and 1310 record the times covered and the appropriate user's rule that covers that block, 1312 stores the information regarding whether the user is deemed available for this block given the parameters of this purchase, if so column 1314stores the price per unit for that block and 1316 the number of units covered by that block. After compilation, the information held in this record about each block of availability may be stored within Historical Datastore 565 and used to produce reports for the seller.

The ordering of blocks within the table illustrated by FIG. 12 could be chronological within the buyer's needs. However, where applicable this list might be ordered such that it produces the simplest rules to check first. Thus, only if a user has not been rejected by the search on the simpler checks is it necessary to perform the more processing intensive checks. This ordering will depend on the complexity of technology required for live checks, for example if the user has invoked the “I am available if contactable” rule. However, by way of example, it might structure blocks of availability by rules based on prioritising the following; (a) any availability rule that leads to a simple action such as D03 (“display my availability to the buyer but make it dependant on my approval after a conversation”.) Where a rule such as this is in force for at least part of the transaction and the user is showing standard availability or conditional availability for the rest of the units required, because it prohibits an immediate sale rule D03 or similar dictates the procedure for this seller for the whole transaction (b) any rule such as P12 which requires a very straightforward check (“I will sell to anyone with a voucher code I have authorised”), PO1 (“I will only sell to named buyers”), P03 (“I will only sell to buyers of a certain grade”). Further rules can be ordered based on the complexity of processing required to assess whether they permit the user to be available at any time. Rules that are not personalised versions of those stored in Availability Rules Store 550 but have been composed from scratch by a user are likely to be the most demanding.

Thus, step 1202 of FIG. 12 has produced the table described above and populated columns 1306, 1308, 1310 and 1316. Availability Search Module 520 now moves to step 1204 and reads the first unsearched rule, it looks this up in the seller's record in Seller Database Extensions 555 which may include a reference to a pre-determined process for the search in Availability Rules Store 550. If the rule was created without a template by a user the information will all be contained within Seller Database Extensions 555, this is checked by verification at the point the rule was input.

The process of establishing availability under a particular rule is now begun and will be described with reference to columns A, B, C and D within FIG. 7 that illustrates the particular requirements for each rule stored in Availability Rules Store 550. At step 1208 the data sources pertaining to that rule, for example those listed in Column A are accessed. At 1210 the required data, for instance that listed in Column B, is extracted. At step 1212, any calculation required, listed in Column C for the example rules given, is performed and the results stored temporarily. At step 1214, the data thus produced is compared with the requirements for availability such as those stored in Column D of the example rules. This may include constructing a price at which the seller will be available for the units covered, said price is entered into the appropriate row of column 1314 in the table shown in FIG. 13.

Step 1216 reads the results of the comparison as stored in column 1312. If the seller is not available under this rule for this block, Availability Search Module 520 checks whether the rule is part of a merged rule where the constituent rules apply independently of each other. If so it searches the other constituent rules and only proceeds to the next step if none of them can be satisfied. If there is no match of availability requirements, at 1232 Assembly of Options Module 424 is instructed that the user is to be rejected by the search for sellers willing to meet this buyer's requirements.

If the seller is available as the result of searching the first block of availability 1220 reads the table shown in FIG. 13 and ascertains whether there is at least one further block of availability covered by this transaction to be searched. If so, steps 1206 to 1220 are repeated for each remaining block.

If the search shows the seller is available for all blocks of availability covered by this transaction, at step 1222, all mandatory actions required by any rule invoked are applied to the transaction file within Application Processor 306. These rules, if required, are listed in column E of the table shown in FIG. 7. At step 1224 any choice of action by the seller governing their future availability, contactability, acceptance procedure and so on are added to the transaction file. These seller chosen actions are typically input through the right hand side of the screen illustrated by FIG. 8. Because there may be a plurality of instructions, each associated with a particular block of availability it is preferred that step 1224 include the rationalisation of said instructions by acting on only the most extensive of the requirements for (a) curtailing future availability (b) changing future pricing, selecting either the biggest rise/fall percentage or the longest running application of that rule, such distinction to be stored within Enhanced Availability Store 560(c) all contactability procedures specified under any rule (d) using the acceptance procedure specified against the chronologically first block of availability within this transaction. Step 1224 may additionally require information be relayed back to inventory management software.

At step 1226 the seller is offered to the buyer by Assembly of Options Module 424, that is; the present seller becomes one of the options displayed on the screen represented by FIG. 2. Price Construction Module 425 calculates the unit price at which they are to be offered for this transaction by (a) multiplying column 1314 by column 1316 for each block of availability, including any covered by standard availability, within this transaction (b) totalling the figures produced (c) dividing the total by the total number of units within the transaction. Thus, the complexity of the seller's willingness to comply with the buyer's needs is simplified to enable the buyer to make instant per-unit cost comparisons of the options available for her need.

Step 1228 waits for a time period stored within Operator Inputs Datastore 575 to see if one or more sellers covered by Conditional Availability has been purchased by the buyer. If not, the process ends, possibly with the store of information, including that shown in FIG. 13 for later reporting to sellers. If purchase is made, at step 1230, all the actions stored in the transaction file are implemented by Post Purchase Module 525. The selected sellers' inventory and availability diary is updated by having the sold units and associated “buffering” removed as previously described and the seller's “My Transactions” list and “My Accounts” screens are updated

Reporting to Users

It is desirable that users of the present invention are able to see an overview of their sales, and potential sales, over any given period of time. Likewise, they should be able to understand the extent to which their patterns of availability are denying them sales they might have made with less restrictive availability. Reporting to users is achieved by Availability Analysis Module 530. Reporting to users should include a screen in which the user can define a time period and then see a representation of the grid shown in FIG. 11 which is color coded according to their personal market activity. That is, in each square of the grid, representing that hour of that day for the defined period, there is a different color representing the percentage of (a) time sold (b) availability offered under each of the seller's rules (c) time for which no availability was offered. The user can then limit the number of rules displayed stipulating for instance “show me all the times I made myself available subject to rule 6 with the percentage that resulted in a sale”. A seller of goods rather than services could see a simpler display perhaps arranged by week, showing offerings under various rules and the percentage that resulted in a sale.

In a further embodiment, by retrieving data in Historical Datastore 565 pertaining to any one seller it is able to produce a screen such as that illustrated by FIG. 14 for that seller. This screen provides an immediate overview of sales made and sales missed over a specified time period. The illustration in FIG. 14 assumes the seller has been active in a market that (a) grades its sellers and displays them by grade to potential buyers (b) displays available sellers in price order with the cheapest in any given grade at the left of the screen.

FIG. 14 is showing, in section 1406, a graphic display of where the present seller was located on every screen on which she was displayed to a buyer in the chosen timeframe. The example assumes a seller who has been promoted from Grade 4, through Grade 5 to Grade 6 in the specified timeframe. Thus, at 1408, she can see that she was displayed 8 times as the cheapest option within Grade 4. Of those 8 bars; 3 are colored black showing that display to a buyer resulted in her being purchased. Thus the user can see at a glance (a) whereabouts she has been appearing on buyer's display screens (b) how many displays at each position resulted in a purchase. By clicking on any one individual bar in this screen she can bring up a “how your price was calculated” screen for that particular purchase. This shows (a) the selling parameters for that potential transaction and how each one contributed to the final price displayed (b) the completed table represented by FIG. 13 if additional availability rules were in force for at least part of the time covered by the transaction. Section 1410 represents places on screen where she was below the 4^{th} cheapest, the actual placing shown by a bracketed number attached to the bar representing each transaction.

Other sections of FIG. 14 will now be explained. 1402 allows the user to narrow the data being displayed to any combination of certain markets and periods covered by any combination of her availability rules. Section 1404 allows data to be narrowed to specific times of day and days of the week and a timeframe specified. 1412a shows the average unit price of all the potential transactions on the screen while 1412b computes the percentage of displayed transactions for which this seller was the cheapest by grade. Section 1412c reports the percentage of total availability units for the defined period, as archived in Historical Datastore 565 from Enhanced Availability Store 560, that were sold.

In a non graded market the screen represented by FIG. 14 would simply show a ranking for the seller's price relative to other available sellers for each transaction. Thus she would be able to see instantly how often she had been the cheapest, how often the second cheapest and so on.

In a further embodiment, Availability Analysis Module 530 might contain the facility to run “what if . . . ” scenarios by (a) accessing historic transaction data of buyers' requirements within Historical Datastore 565 over a given period (b) running an additional seller search and price construction for each relevant buyer requirement for a seller who was not available or had different terms of availability at the time (c) comparing the additional seller with the actual results of the search at the time to compare their performance with sellers who were actually available and determine whereabouts on the buyer's screen they would have been placed if they had actually been available. This functionality could be used to confirm the wisdom of new entries by a seller. Thus, a seller who plans to start offering new availability at new times can have those times and conditions of availability run through perhaps the last 4 weeks of stored transactions in Historical Datastore 565. A screen like that shown in FIG. 14 can then be produced to show where he would have appeared on each buyer display for each transaction in that time for which his inputs would have qualified him. Clearly all displays would be gray, as the availability did not exist at the time if could not have resulted in a purchase. Once again, he can click on any transaction to see how his price would have been constructed although any information identifying the buyer in that actual transaction should be omitted for privacy protection reasons.

Likewise, a seller who is completely new to the system can input their planned availability and rules and immediately be shown where they would have appeared on buyer screens under those terms for actual transactions over the previous 4 weeks or other timeframe. Clearly all hypothetical searches of this nature have to factor in a time in advance of the availability when each period of hypothetical past availability was presumed to have been input.

In a further embodiment of this functionality, a seller who is undecided about whether to start selling in the system of marketplaces associated with the present invention is enabled to input the times and terms of the availability under which they might sell and then see a screen such as that shown in FIG. 14 that builds progressively from that point on. Their availability is included where relevant by Enhanced Availability Store 560 and the price they would charge under their terms is constructed but the information is not displayed to the buyer and is not reflected in the final ranking of actually available sellers. Instead the seller's screen shows where that seller would have appeared on the screen if they had been actually available. In an additional embodiment this facility may be used as the basis for conditional availability. Thus a seller is able to specify “if I have appeared as the cheapest option for X buyers in Y market in the last hour (or other timeframe) I will be available for the following hour (or other timeframe)”.

In a further embodiment of the seller reporting function, the seller may be able to use a screen like that in FIG. 14 to examine “what if . . . ” scenarios around different types of availability. Thus she could input “change all my past rule 17 availability to rule 4 ” and Availability Analysis Module 530 arrive at a screen showing where she would then have been placed on each display to buyers for which she would have been eligible with her price calculated.

Similarly, the seller could change her selection for a particular rule specifying for example, “change the threshold for my rule 23 from $100 to $200”. Availability Analysis Module 530 would then display her place on the screen of any historic buyer requirements for which she would have been eligible. Clearly these hypothetical purchases can not show any displays that might have lead to a purchase but might show that, by changing her rules, she would have shown up as a cheaper option for a lot more potential transactions. To make the data displayed more meaningful it might contain only buyer requests that led to a purchase not all buyer requests stored in Transaction Database 433.

Other Means of Achieving the Objectives of the Present Invention:

It will be appreciated by one skilled in the art that the aims of the present invention could be achieved by other means. These might include, the construction of availability rules based on the default assumption of availability with sellers then setting the terms under which they are to be ruled out. (For example: “I am available unless the number of sellers in my market rises above X % of a historic average”.) This is simply another way of achieving the aims of the present invention which, in the embodiment described in this document, is based on the default assumption of no availability unless proscribed conditions are found to be in force. Similarly availability could be decided by reading external data for example from other websites or information channels without compiling it in advance in a unit such as External Variables Datastore 570.

Alternatively, the binary availability store labelled Seller Availability Record 431b in this document could be dispensed with and only the store labelled Enhanced Availability Store 560 used. This has the advantage of simplicity but has the drawbacks of (a) requiring the complexity of Enhanced Availability Store 560 to be installed from the launch of the marketplace rather than being added later as usage deepens (b) making it harder for Availability Server 500 to simultaneously serve multiple marketplaces, each of which may have its own form of availability diary already in place.

Another way of achieving the objectives of the present invention might be to forgo rules constructed in advance by users and allow terms of availability to be made up at the point of inputting availability. This is a version of the present invention that does not permit the sophistication described in this document.

Other means of allowing sellers in a market to specify a plurality of conditions for availability to sell that enable immediate assessment of their willingness to provide for a particular buyer's needs will doubtless occur to the qualified person. They are all claimed within the scope of the present invention.

Additional Embodiments of the Present Invention

Availability Diary Enhancements

Dynamic buffering embodiment: Rather than applying a uniform formula for “buffering” to cover a seller's travel between assignments, Seller Database Extensions 555 might store a default formula but allow sellers to input their own. Components of said formula would include (a) time user believes they need to travel a range of given distances (b) changes to that formula by percentage based on times of day and days of the week (c) changes to that formula based on area covered. This facility is particularly useful in a marketplace which penalises sellers for non-compliance with transactions they have undertaken. If dynamic buffering is enabled the seller is not able to claim unrealistic travel times imposed by the system as a reason for lateness.

Floating break embodiment: A seller may wish to specify that they need a break in their availability within a certain period, for example to take a meal break, but that they wish to take it when it is commercially favourable to do so rather than at a proscribed time. Thus a user might specify they are available from 8.00 to 19.00 as long as they get a break of an hour between 12.00 and 16.00. If the period of availability results in only one assignment this can be achieved by ensuring a match with the buyer's willingness to allow a break of the required length within those hours. If the seller is making multiple sales in that period, for example a minicab driver, Availability Search Module 520 will allow selling of availability only until a required break window remains. This embodiment could be turned into a pricing rule in which a user will work in that chosen break area but only for an increased price.

Frivolous availability removal embodiment: the historic availability records of sellers in a system of marketplaces may be audited to assess whether they have genuinely been attempting to make sales or simply displaying availability, that makes it look like they wish to sell, while in reality imposing rules on that availability that make it highly unlikely they will make any sales. Such audit might for example be a condition of grant payment or to ensure compliance with a condition of investment in their trading activities. In an electronic marketplace such audits are likely to be automated.

A distinction therefore needs to be made between availability rules that are enabling, that is they make a sale more likely and those that are restricting, they make sales less likely than if the seller's normal parameters were in force. A grant giver or investor may set sales parameters required of a seller and a minimum number of units of availability they demand be offered within a given timeframe. They then need to ensure the seller is not using the present invention to restrict sales to a minimum. This can be achieved by categorising rules by their effect on availability relative to the user's normal parameters. For the examples given in the present document, the categorisation, stored in, Availability Rules Store 550 would be thus:

| RULE | RULE STATUS |
|---|---|
| CP01 | Restricting if narrowed terms, Enabling if wider terms |
| P01 | Restricting |
| P02 | Restricting |
| P03 | Restricting |
| P04 | Restricting |
| P05 | Restricting - (it limits the buyer's choices) |
| P06 | Enabling - if the other seller was available at the time |
| P07 | Status depends if the desired purchase was possible |
| P08 | Restricting |
| P09 | Enabling |
| P10 | Restricting |
| P11 | Restricting |
| P12 | Restricting - if used to exclude non voucher buyers |
| M01 | Status depends if availability terms were met |
| M02 | Status depends if availability terms were met |
| M03 | Enabling |
| M04 | Enabling |
| E01 | Status depends if availability terms were met |
| E02 | Status depends if availability terms were met |
| E03 | Enabling |
| E04 | Status depends if availability terms were met |
| E05 | Restricting |
| E06 | Restricting (could be used in a no-sales location) |
| F01 | Enabling |
| F02 | Enabling |
| F03 | Restricting if narrowed terms, Enabling if wider terms |
| D01 | Restricting |
| D02 | Restricting |
| D03 | Restricting |

In a further embodiment the user might be advised if they are entering what will be deemed frivolous availability at the time they enter it, that is when they click the Submit button on the screen represented by FIG. 10.

Display control embodiment: Availability rules input by means of a process such as that illustrated within FIG. 8 might include the means to further dictate how a seller is displayed to potential buyers. For example, a seller may be allowed to stipulate the market sectors in which the availability applies exclusively. For example they may wish to have very limited availability in one market and merge that with a rule giving them broad availability in others. Additional rules may then be applied to potential sales in certain market sectors only.

Tentative sale embodiment: a seller may wish to only commit to a sale once a required number of buyers have been recruited. For instance, a tutor selling language lessons may only consider it worthwhile running the proposed classes if a minimum of ten students are signed up. This embodiment allows her to input tentative availability. This requires her to (a) specify broad details of the service on offer and its dates/times (b) specify the minimum number of buyers required (c) input the maximum number of buyers to be accepted (d) define the time at which the offer will be withdrawn if the required number of buyers have not been found.

Tentative availability that meets a buyer's needs appears as a separately colored option on the screen represented by FIG. 2. If selected it might reveal the details of (a) above and display (b) (c) and (d) together with the present number of committed buyers. A buyer can then input a commitment to purchase assuming the sale is eventually offered. When point (d) is reached he is informed of the outcome. This embodiment might be most useful in conjunction with the incremental pricing option listed below to encourage early buyers.

Price Construction Enhancements

Price undercutting embodiment: A seller may wish to define their availability in terms of their pricing relative to the rest of the market. For example: “If I haven't worked in the previous 2 days I wish to start being the cheapest seller (or within X % of the cheapest) on every screen of buyer options on which I appear”. Market operators may take the view that such a rule is not permissible because (a) it can result in circular arguments, if everyone is determined to be cheapest there can be no price with which to begin calculations (b) sellers may find themselves unintentionally committed to transactions at prices they had not foreseen because of another seller's anomalous price instructions (c) the means of constructing price in a “GEMs” type marketplace as described allows pricing that accurately reflects the cost and desirability of a particular transaction for a particular seller, there is little point in being the cheapest if it costs the seller more to fulfil a transaction than someone else who is nearer and better equipped.

However, markets with advance price construction based on multiple parameters can allow undercutting as an over-riding principle of price construction. A taxi driver who is commissioned for a journey from X to Y for example may then want Price Construction Module 425 instructed to automatically undercut all other sellers for a return journey that he is going to have to make anyway. Clearly undercutting has to be limited to avoid the problems above but it might be allowed as a rule stored in Seller Database Extensions 555 by a user that can only be applied if (a) fewer than X % of a pool of sellers for a given buyer's requirement are allowed to invoke the facility (b) priority for the facility is determined by the first sellers to apply that rule to the relevant block of availability (c) the price differential between the lowest price constructed without this facility and the price generated by a user of this facility is determined by the relevant seller in advance (d) if more than one seller on a list of options is using this facility they are all calculated on the basis of the cheapest seller not using this facility, they do not drop in price relative to each other. In a further embodiment of this option sellers may be permitted to undercut prices in an adjoining market; for example, a minicab driver could set her pricing for long distance hires relative to the cheapest price that would be charged in the coach journeys market for the same journey.

Payment among sellers embodiment: In cases such as rule P05 where two or more sellers are only available as a grouped purchase Seller Database Extensions 555 might store details of a levy to be paid to one of the sellers by the others. Typically this would be used if one seller provided transport to the others. The levy could be calculated on the basis of distance and deducted automatically when payment from the buyer was received.

Personalisation of price increases embodiment: sellers may be allowed to increase or decrease their rate based on certain parameters by actual currency amounts rather than percentages of the base price. However, this would make it less easy to for them to coherently manipulate overall prices by changing the base price. Similarly users may be enabled to set their own increments for price calculation. For example a user could specify; “If I get less than 27 minutes notice of a job I charge an extra 12%”, “If I get less than 43 minutes I charge an extra 18%” and so on. Additionally users may be given the facility to add a flat rate “call out” charge to their rate that is applied to each assignment and added to the price calculated from their stored information.

Cancellation pricing embodiment: Sellers may be given the means to set a cancellation charge as part of any period of availability, possibly based on a sliding scale that defines the percentage of the fee to be charged relevant to the notice with which the job is cancelled. A seller is cancelled before or during the period of a transaction by a buyer's inputs. The seller may then have the availability and buffering that was removed to allow them to fulfil that transaction reinstated in Enhanced Availability Store 560 so they can be immediately bought by another buyer.

In a further embodiment of a cancellation function, the seller could be released back into the market and the amount they subsequently earn in the restored availability totalled, the original buyer is then billed for any shortfall in earnings or the shortfall plus an additional fee to compensate for inconvenience. It may be that automated price undercutting is allowed under these conditions as it is in both buyer and seller's interests that a new buyer is found promptly. In an additional embodiment a seller's cancellation fees might be calculated at the point of cancellation based on the likelihood that they will be able to re-sell their offering. This would factor in (a) the number of units of time before the reinstated availability starts as a percentage of the number of units of time between the original booking and the start time of the transaction (b) the historic frequency of purchases in that market in the area in which the seller is willing to transact at that time over a given period as a percentage of the same figure applied to all markets and all geographical areas covered by the underlying system of marketplaces in the same timeframe, if relevant purchases are frequent the cancellation rate will be lower (c) the number of available sellers in the relevant market/area at the time of cancellation as a percentage of historic averages over a given timeframe, if there are few sellers, the cancellation rate falls. Data for (b) is extracted from Transaction Database 433. Data for (c) is extracted from Enhanced Availability Store 560 and compared with historic data contained within Transaction Database 433. Thus, by way of example, a cancellation charge for a particular assignment might be a weighted version of the following formula using the three characteristics above: price that was to have been paid for the assignment multiplied by (100%-(a)), multiplied by (100%-(b)), multiplied by (c).

Standby-availability embodiment: There are times when a user wishes to book buyers' offerings not knowing if they will ultimately be required or not. If a fee is paid for thus reserving a particular seller, this can work to the advantage of both buyers and sellers because sellers can effectively be paid for nothing more than taking their availability out of the market pending a decision by the buyer. Thus Seller Database Extensions 555 might facilitate users specifying times for which they are willing to be put on standby subject to their requirements for (a) charge to the buyer (b) the period by which they must be either confirmed or released from a period of stand-by (c) any automated actions the user wishes the system to take if they are released without being purchased. This assumes that, if the buyer exercises his option to purchase the provisionally booked availability, the seller is bought at the rate they would have charged for a given period of availability subject to all other pricing rules in force at the time of purchase.

Dynamic construction of seller parameters embodiment: Sellers in an arena such as the “GEMs” type markets described earlier construct their price around certain pre-defined parameters of a buyer's need such as distance to be travelled, period of notice, length of work shift and so on. This enables a price to be constructed at the point of buyer enquiry that immediately reflects a particular seller's willingness to fulfil a particular requirement. Sellers may wish to add to this list by submitting a question relevant to their market and the suggested increments against which price can be increased or decreased, by the individual seller. These potential questions, stored in Seller Database Extensions 555 for that seller can become a condition of a seller's availability for certain assignments, are then offered to buyers who wish to engage with a wider range of sellers.

For example a seller in the camera repairs market might pose a range of questions such as (a) has the camera been exposed to a hostile environment such as water or dust? (b) does the camera fail to wind film? (c) is light leaking into the film chamber? The user can then insert a percentage of base price to be added to or subtracted from the price if the buyer answers “Yes” to a particular question. Such questions are least demanding of buyers when they are merged into a coherent list against which any seller can set up pricing parameters. It may therefore be that when certain conditions are met Sweeps Module 535 will forward the list of unclassified questions in a market to a high grade or other seller in the relevant market with the request that they turn them into a coherent list, possibly in return for a payment. The returned list is then incorporated into Availability Rules Store 550. Conditions to be met might include (a) a threshold number of outstanding question lists in one market (b) value of said market (c) presence of a suitable user who has indicated a willingness to perform this function.

Incremental pricing embodiment: a seller who requires multiple buyers to enable a sale, such as a coach travel company, might wish to specify that their first 10 seats be sold at price A, the next 10 at price B and so on. Selection of price change points and the new price can be made by Drop Down Box. If this is used to determine only the base price, before calculations made by the present invention that might for example, factor in the desirability of each potential passenger to the operator, sophistication in price construction is immediately available. In a further embodiment the price change points could be relative to the beginning of the availability block.

Single seller embodiment: with slightly altered screen displays, the present invention could be used by a single seller who has multiple buyers. The seller would thus be able to control their interaction with their buyers more precisely. For example, a driving instructor selling hour long lessons might choose to be available under multiple versions of rule P01, when a new student is enrolled that student is allocated a set of parameters, including price, under which they can buy lessons. By merging all these rules independently, the instructor might then specify that she is available for lessons at certain times, each student can call up a display of still available lesson times with the price at which each can be bought. To make the seller's life simpler the present embodiment might include one screen within which they can (a) enter a new student's details (b) attach any number of rules to that buyer (c) remove students with whom they no longer have a relationship.

Descriptions of the system above have assumed a wide ranging system of markets. The invention applies equally to a narrow range of markets, for example a market for secretarial services with sectors covering medical, legal, educational and commercial secretaries as a system of markets.

In above described embodiments of the system the Internet, and more specifically web technology, is used for communication between a central computer system and the buyers and sellers. However, it is not necessary to implement the invention using the Internet and the system may, for example, be implemented on local or wide area networks, wireless mobile communications networks, cable tv networks and the like. Similarly, the terminals used by the buyers and sellers for communicating with the central computer system may comprise mobile phone handsets, personal digital assistants, inter-active televisions and the like. Likewise, as it is well known to those skilled in the art, the processing for performing the functions described above may be shared between machines in ways other than that shown in the illustrated embodiments.

No doubt many other effective alternatives will occur to the skilled person and it will be understood that the invention is not limited to the described embodiments and encompasses modifications apparent to those skilled in the art lying within the spirit and scope of the claims appended hereto.

1. A transaction management system for managing the purchase of a product or service by a buyer from a seller, the system comprising:
a data store for storing seller data comprising, for each of a plurality of sellers, a seller identifier;
a program store storing processor implementable instructions; and
a processor coupled to the data store and to the program store for implementing the stored instructions, wherein the stored instructions comprise instructions for controlling the processor to implement a seller interface to receive seller offer data from a seller, the seller offer data including an availability record for a product or service offered for sale, the availability record defining a plurality of periods of conditional availability, each period of conditional availability having an associated set of conditions under which the product or service is or is not available.

2.-72. (canceled)
